(19) United States
(12) Patent Application Publication
(10) Pub. No.: US 2026/0359559 A1
(43) Pub. Date: Nov. 12, 2026

(54) GRAPH-BASED ELECTRONIC DOCUMENT PROCESSING PLATFORM

(71) Applicant: Genpact USA, Inc., New York, NY (US)

(72) Inventors: Vivek Saxena, Gurgaon (IN); Maria-Laura Sorea-Chirca, Tunari (RO); Lavi Sharma, Gurgaon (IN)

(21) Appl. No.: 19/201,387

(22) Filed: May 7, 2025

(51) Int. Cl. G06F 40/186; G06F 40/20

(52) U.S. Cl. CPC G06F 40/186; G06F 40/20

(57) ABSTRACT

An electronic document processing platform includes a multi-layer control graph, where interconnected nodes within a multi-layered structure of the control graph include electronic documents stored at one or more locations in a computing network, and where edges of the control graph include relationships among the electronic documents including shared risks, cascading impacts, and operational dependencies. The electronic document processing platform further includes an adaptive dimension algorithm module configured to dynamically scan contents associated with the electronic documents, and a generative compliance engine configured to synthesize contents associated with the electronic documents based on the relationships in the control graph.

### TECHNICAL FIELD

This disclosure generally relates to computer systems and methods for electronic document processing, and more particularly to techniques for graph-based automated electronic document creation and updating.

### BACKGROUND

Current electronic document creation, synchronization and management methods are hindered by traditional, manual approaches that result in significant inefficiencies. The process involves subjective manual analysis, limited access to internal and external data sources, as well as, in some instances, labor-intensive research, all of which make the process highly prone to human error. Coordination between all parties involved typically relies on inefficient information exchanges, leading to delays and miscommunications. Finalization and communication steps are cumbersome, and manual monitoring to ensure related electronic documents are synchronized is inefficient and lacks real-time updating mechanisms, which may put organizations in high-risk operation scenarios.

For example, cyber threats are constantly evolving, and relying on outdated electronic documents relating to cybersecurity (including, for example, software configuration files, firewall rules, security procedures, etc.) leaves organizations exposed to the latest tactics used by attackers. Key risks include but are not limited to ransomware, phishing, and zero-day exploits. For example, without updated firewall configurations, critical data and systems are at risk of encryption and extortion. Organizations may also lack preventive measures like robust backups or endpoint detection systems. In addition, outdated cybersecurity-related documents may not cover recent phishing strategies, such as sophisticated spear-phishing campaigns targeting executives (whaling) or phishing via social media. Further, a lack of real-time monitoring and patching mechanisms can allow attackers to exploit newly discovered vulnerabilities before they are publicly addressed. Timely updates to cybersecurity-related documents are thus critical to ensuring a proactive and effective incident response. Risks of neglect may include but are not limited to detection delays, response gaps, and extended recovery times. For example, outdated cybersecurity-related documents may not include updated logging, monitoring, or alerting systems, delaying the identification of attacks. In addition, an incomplete response framework may fail to contain incidents, allowing them to escalate and cause greater damage. Exemplarily, specific protocols for handling ransomware, insider threats, or data breaches may be absent or outdated. Further, without current best practices, recovery measures (e.g., data restoration, system reconfiguration) may take longer, increasing downtime and operational losses.

Currently, many attempts to address these issues in electronic document creation, synchronization and updating have included digital tools and industry-specific software to enhance data handling and benchmarking including improved automation. However, these digital tools and software applications are fragmented, siloed, bias-prone, disconnected, and lack comprehensive integration of diverse regulatory landscapes, and require significant human oversight. For example, an access configuration file update within one portion of an enterprise network may affect another access configuration file within a different portion of the network, e.g., relating to data storage or data access, which may further affect another access configuration file, e.g., for specific document access or management. Current digital tools and industry-specific software for automated management of these documents can focus on one aspect, but cannot effectively address interplay and interdependencies among different documents within an organization.

Accordingly, there is a need for improved digital tool or software application that is capable of dynamically evaluating including automatic creation and/or updating electronic documents in real time, especially a digital tool or software application that is capable of accurately capturing the complicated relationships among different electronic documents and respective control elements during dynamic document creation and update in complicated environments.

### SUMMARY

To address the aforementioned shortcomings, an electronic document processing platform is provided, where interconnected nodes within a multi-layered structure of the control graph include electronic documents stored at one or more locations in a computing network, and where edges of the control graph include relationships among the electronic documents including shared risks, cascading impacts, and operational dependencies. The electronic document processing platform further includes an adaptive dimension algorithm module configured to dynamically scan contents associated with the electronic documents, and a generative compliance engine configured to synthesize contents associated with the electronic documents based on the relationships in the control graph.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates an overall architecture of a graph-based electronic document processing platform, according to some embodiments of the disclosure.

FIG. 1B illustrates an exemplary multi-layer control graph, according to some embodiments of the disclosure.

FIG. 2 is a block diagram of an example process flow of a graph-based electronic document processing platform, according to some embodiments of the disclosure.

FIG. 3A is a block diagram of an example overall architecture of a graph-based electronic document processing platform, according to some embodiments of the disclosure.

FIG. 3B illustrates example components included in a data processing unit, according to some embodiments of the disclosure.

FIG. 4 illustrates example components included in an electronic document assessment and generation engine, according to some embodiments of the disclosure.

FIG. 5 illustrates example components included in a query engine, according to some embodiments of the disclosure.

FIG. 6 illustrates example components included in a dissemination engine, according to some embodiments of the disclosure.

FIG. 7 illustrates example components included in a dashboard architecture, according to some embodiments of the disclosure.

FIG. 8 is a flow chart of an example method for AI-driven electronic document processing, according to some embodiments of the disclosure.

FIG. 9 is a block diagram of an example implementing device for a graph-based electronic document processing platform, according to some embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for illustration purposes only. One skilled in the art will readily recognize from the following description that alternative embodiments of the structures and methods illustrated herein may be employed without departing from the principles described herein.

To address the aforementioned problems in the existing electronic document processing, the disclosure provides a graph-based electronic document processing platform, which represents a paradigm shift in electronic document processing, transitioning from fragmented, manual, and bias-prone processes to a unified, intelligent, and automated system. It integrates essential control elements such as organizational integrity, strategic risk profiling, robust control protocols, oversight, and continuous assurance into a node-based graph ecosystem. By using a graph-based approach to address many subject-related issues including but are not limited to regulatory, cyber, reputational, governance, and operational risks, it delivers enhanced compliance, improved user experience, stronger internal controls, and heightened operational efficiency. The system's autonomous electronic document creation and drafting capabilities further redefine traditional methods, enabling organizations to proactively manage complex electronic documents with precision and agility.

At the core of the graph-based electronic document processing platform is a multi-layer control graph, which represents risks, and control elements as interconnected nodes within a multi-layered structure, where relationships such as shared risks, cascading impacts, and operational dependencies are modeled as edges. This contextual representation enables a dynamic and relational understanding of how electronic documents influence one another across various dimensions, including but not limited to regulatory and operational aspects. In other words, the multi-layer control graph disclosed herein is a dynamic, graph-based framework configured to represent the complex relationships between various aspects within electronic documents distributed in one or more locations in a computing network (which can be an organization computing network or other types of computing network). Designed as the backbone of advanced electronic document processing systems, the multi-layer control graph may enable a holistic and real-time understanding of electronic document interdependencies across multiple dimensions. It achieves this by organizing these subjects into distinct layers, each capturing a specific aspect of the electronic document landscape, while maintaining the interconnected nature of their interactions. This architecture provides organizations with actionable insights into how changes in one area propagate across the broader ecosystem, for example, through the adaptive dimension algorithm as will be described more in detail later.

By incorporating multi-modal graph analysis and advanced algorithms, the graph-based electronic document processing platform provides actionable insights that go beyond traditional electronic document-based monitoring systems.

Additionally included in the graph-based electronic document processing platform is an AI-powered electronic document nexus that is configured to synthesize certain subject-specific factors, regulatory compliance requirements, national or international standards, generally accepted principles, and organizational objectives to autonomously generate and evaluate some subject-specific electronic documents. By eliminating manual analysis and inherent biases, the AI-powered electronic document nexus ensures that the automated generated electronic documents align seamlessly with regulatory requirements and national/international standards and organizational goals. This capability is essential for maintaining compliance in diverse and rapidly evolving environments.

Additionally included in the graph-based electronic document processing platform is a content intelligence hub that transforms electronic document creation and review by automating risk categorization and eliminating biases. It provides actionable insights, enabling data-driven decisions and ensuring that the generated electronic documents are inclusive and contextually relevant to the subject. Leveraging continuous learning capabilities, the content intelligence hub refines its contextual understanding, rationalizing content inclusion and ensuring that the generated electronic documents remain adaptive to organizational and regulatory shifts.

Additionally included in the graph-based electronic document processing platform is an autonomous electronic document renewer that dynamically updates the generated electronic documents by employing a dimension algorithm that considers changes in organizational structures, strategic risk profiles, and regulatory requirements. It ensures real-time alignment with local laws, such as cybersecurity regulations. By doing so, it guarantees that the generated electronic documents are current and effective, mitigating compliance risks and reinforcing organizational governance.

In addition to these capabilities, the graph-based electronic document processing platform autonomously orchestrates educational and adherence campaigns, ensuring that relevant entities are well-informed about electronic document changes. This feature enhances engagement, facilitates smoother electronic document-initiated implementation, and promotes compliance through clear communication and targeted training initiatives.

The graph-based electronic document processing platform disclosed herein thus addresses many challenges in the current electronic document processing, which significantly improves efficiency, accuracy, and compliance by integrating advanced technologies into a comprehensive and adaptive electronic document processing framework.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

In the following, the graph-based electronic document processing platform is described with reference to specific electronic documents within organizations. However, it is to be noted that the disclosed graph-based electronic document processing platform is not limited to the electronic documents within organizations, but can be applied to many other different types of electronic documents that are generated or to be generated and managed through specific computer-rooted technologies or tools. It should also be noted that, the electronic documents described herein specifically refer to the electronic documents that are generated and managed under computing environments, which include certain features not achievable through traditional physical or static documents. For example, the electronic documents described herein may be automatically generated through certain generative AI tools without requiring human manipulation. For another example, the electronic documents described herein may be automatically updated through the same AI tools or other different tools without human intervention. There are also many other features, in the electronic documents described herein, that cannot be achieved through conventional physical or other existing static documents, as will be described more in detail in the following sections.

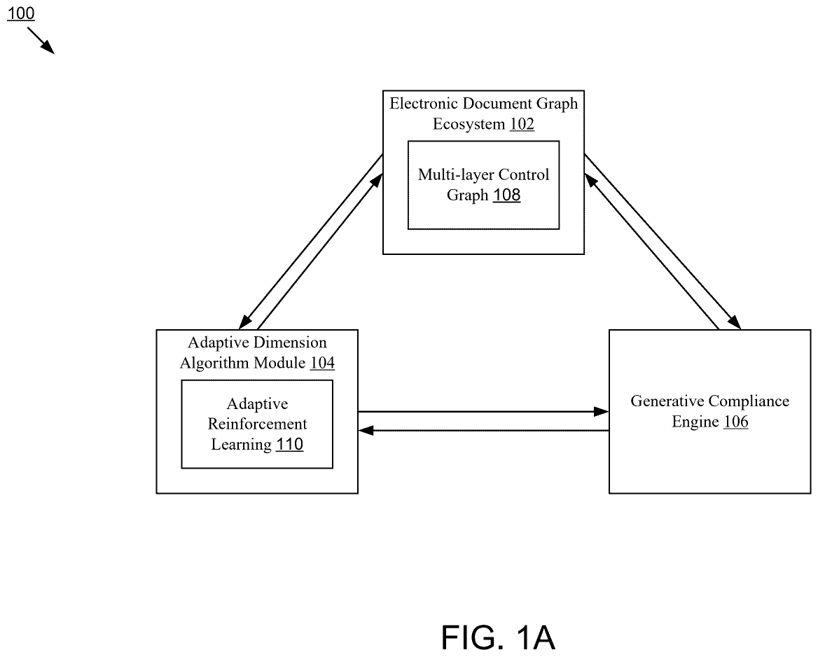

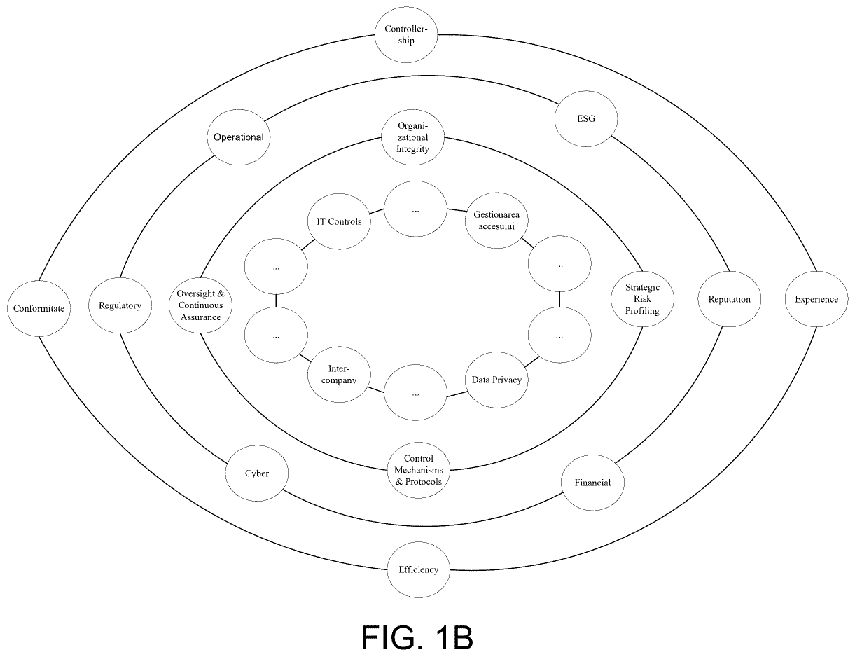

FIG. 1A illustrates an overall architecture of the disclosed graph-based electronic document processing platform or system 100, according to some embodiments of the disclosure. As shown in the figure, the disclosed graph-based electronic document processing platform integrates several unique components, to establish an intelligent, adaptive electronic document processing system 100. The exemplary components included in the system 100 include but are not limited to an electronic document graph ecosystem (EDGE) 102, adaptive dimension algorithm module (ADA) 104, and generative compliance engine (GCE) 106. Optionally, the electronic document graph ecosystem 102 may include a multi-layer control graph (MLCG) 108, and the adaptive dimension algorithm module 104 may include an adaptive reinforcement learning (ARL) mechanism 110, as shown in FIG. 1A.

The EDGE 102 is a graph-based electronic document intelligence framework configured to transform the way organizations manage and analyze interdependencies among different electronic documents within an organization. As described earlier, at the core of the graph-based electronic document processing platform is a multi-layer control graph, which represents risks and control elements as interconnected nodes within a multi-layered structure, where relationships such as shared risks, cascading impacts, and operational dependencies are modeled as edges.

According to some embodiments, the multi-layer control graph 108 may include three primary layers: control layer, risk layer, and benefits layer, as described above. The control layer may represent critical control elements linked to electronic documents, such as security protocols or oversight mechanisms, which mitigate risks and ensure compliance of the electronic documents. The risk layer may map key risk dimensions, including but not limited to operational risks such as cybersecurity risk and data privacy risk, associated with each electronic document. The benefits layer may capture measurable outcomes like compliance efficiency, environmental, social, and governance (ESG) impacts. Nodes within each layer represent specific features (e.g., risk or control), and edges between nodes reflect relationships such as cascading risks, shared dependencies, or overlapping controls. According to some embodiments, the relationships represented by edges may be uni-directional or bi-directional.

FIG. 1B illustrates one exemplary multi-layer control graph, according to some embodiments of the disclosure. As illustrated, the electronic document nodes for an organization may include but are not limited to a data privacy node, IT control node, intercompany node, access management node, etc. In addition, there are additional control element nodes, which may include but are not limited to an organization integrity control node, strategic risk profiling control node, control mechanisms and protocols control node, oversight and continuous assurance control node, etc. The risk nodes may include but are not limited to a regulatory risk node, cyber risk node, data privacy node, reputation risk node, ESG risk node, and operational risk node, etc. In some embodiments, there are additional benefit nodes, including but are not limited to compliance benefit node, experience benefit node, controllership benefit node, efficiency benefit node, etc. It can be seen that these nodes are interconnected with a multi-layered structure. In some embodiments, relationships are models are edges, which are indicated by arrows in FIG. 1B. In addition, relationships are also governed by layers, for example, the outer layers may govern or affect the nodes in the inner layers. Each relationship is a directed edge that defines dependencies between electronic documents, risks, controls, and benefits. Electronic documents connect to relevant risk nodes, which in turn link to control mechanisms that mitigate those risks. Control nodes influence benefit nodes, quantifying electronic document-governed effectiveness. The graph structure allows cascading effects, e.g., when an electronic document or regulatory change occurs, the impact propagates dynamically through related risk and control nodes, ensuring alignment across governance layers. The system uses a proprietary risk diffusion algorithm to update dependencies in real time, preventing inconsistencies and ensuring compliance integrity.

In some embodiments, the EDGE 102 may be further equipped with an anomaly detection mechanism that uses unsupervised learning techniques, such as spectral clustering, to identify contradictions, redundancies, or conflicts between electronic documents or between nodes representing the content of these electronic documents. This capability may help organizations maintain consistency across their electronic documents and ensure alignment with overarching compliance objectives. Furthermore, the EDGE 102 may incorporate contextual embeddings to enhance its understanding of electronic document relationships, enabling it to align the content of the electronic documents with evolving regulations and organizational priorities in real time.

The key differentiator of the disclosed EDGE 102 lies in its ability to offer real-time, relational electronic document processing. Unlike static systems, the EDGE 102 may dynamically update its graph structure as new regulations emerge or organizational changes occur. By leveraging this ecosystem, organizations gain a holistic view of their electronic document landscape, allowing them to anticipate risks, optimize controls, and achieve better alignment with strategic goals. In doing so, the EDGE 102 may empower organizations to stay agile and resilient in an increasingly complex regulatory and operational environment.

Referring now to the ADA 104, which is a multi-dimensional algorithm configured to dynamically evaluate and benchmark electronic documents in real time. It operates as the analytical core of the disclosed electronic document processing system 100, leveraging computational methods to assess complex compliance landscapes and organizational performance. According to some embodiments, the ADA 104 may be built upon three key pillars: feature space mapping, a multi-agent system, and dynamic recalibration. Together, these components may ensure continuous adaptability to evolving regulations, operational conditions, and strategic priorities.

According to some embodiments, the ADA 104 employs feature space mapping to represent electronic documents in a high-dimensional space, where each dimension may correspond to a critical compliance factor, such as regulatory integrity or ESG compliance. Tensor decomposition may be then used to distill complex, multi-factor relationships into manageable representations, enabling precise evaluation of electronic documents. In some embodiments, by mapping electronic documents into this graph ecosystem, the ADA 104 may create a comprehensive structure for analyzing and comparing compliance metrics across multiple dimensions simultaneously.

In some embodiments, the ADA 104 may utilize a multi-agent system, where autonomous agents are assigned to evaluate specific dimensions of compliance. These agents may operate collaboratively under a central decision module, employing reinforcement learning (RL) to refine their assessments. The RL framework enables the agents to explore various compliance scenarios and learn optimal responses based on real-time feedback. For example, one agent may focus on cybersecurity implementation risk mitigation, while another addresses cybersecurity regulatory adherence. The interplay between agents ensures a holistic evaluation of electronic documents and allows the algorithm to identify both direct and indirect impacts of electronic document changes.

In some embodiments, the ADA 104 may use a risk diffusion algorithm (RDA) to model and propagate the impact of electronic documents including their effects, risks, and control changes across the multi-layered control graph. This algorithm is a critical component of the disclosed electronic document processing system 100, enabling organizations to evaluate cascading effects, identify vulnerabilities, and ensure consistency in their frameworks. Unlike static or siloed risk assessment methods, the RDA may dynamically adjust and recalculate impacts in real time, accounting for complex interdependencies between nodes in the multi-layered control graph.

In some embodiments, the ADA 104 may operate within the MLCG 108 to dynamically scan contents associated with the electronic documents. For example, when a change occurs in one node (e.g., an electronic document update or a risk anomaly has surfaced through external data pipelines/the introduction of a new risk), the RDA may be configured to propagate the effects across the graph using a risk propagation model. For example, the risk propagation model may assess the weight and influence of each node and edge, and then calculate how far and how strongly the change affects other interconnected elements.

In some embodiments, the propagation process may involve several computational techniques. For example, each edge in the MLCG 108 may be assigned a weight, representing the strength of the relationship between nodes. The RDA may calculate the influence of a change using weighted aggregation, where the impact on a connected node depends on the magnitude of the change and the strength of the connecting edge. Additionally, the RDA may incorporate Bayesian inference models to predict the probability of cascading effects, enabling the system to assess not only immediate impacts but also secondary and tertiary consequences.

A distinctive feature of the RDA is its ability to account for multi-layered interactions. For example, a change in a node at the control layer (e.g., an IT security electronic document) may propagate upward to the risk layer, increasing cyber risks, which may then cascade to the benefits layer, impacting compliance or reputational outcomes. The RDA may ensure that all such interdependencies are dynamically evaluated and updated in real time, providing a holistic view of the potential consequences.

The RDA may offer several key advantages. It provides real-time insights into how changes ripple through interconnected systems through the control graph, enabling organizations to anticipate and mitigate risks proactively. It ensures the alignment and consistency among the electronic documents, reducing vulnerabilities caused by overlapping or contradictory controls. Furthermore, by offering a clear visualization of risk propagation paths, the algorithm supports data-driven decision-making, empowering relevant entities to optimize automated electronic document creation and update and controls for better governance outcomes.

In summary, the RDA is a transformative tool that brings precision and adaptability to electronic document processing. By dynamically modeling the cascading impacts of changes across a multi-dimensional graph, it enables organizations to navigate complex regulatory and operational landscapes with confidence and agility.

In some embodiments, the ADA 104 may further include a multi-dimensional risk and control optimization (MDRCO) algorithm configured to score and optimize electronic document creation and update by analyzing their performance across multiple dimensions. The MDRCO algorithm is a sophisticated framework designed to evaluate and optimize electronic documents by analyzing their impacts across multiple dimensions, such as regulatory compliance, cybersecurity implementation efficiency, and operational risk. By combining advanced mathematical modeling with real-time data analysis, this algorithm helps organizations prioritize electronic document updates and control adjustments to mitigate risks effectively while enhancing overall efficiency.

Specifically, the MDRCO algorithm may evaluate each electronic document using a comprehensive risk score (RRR), which is derived from multiple risk dimensions:

$$R = {\sum }_{i = 1}^{n} {w}_{i} * {r}_{i}$$

where wᵢ is the weight assigned to each risk dimension, reflecting its relative importance (e.g., regulatory compliance risks might be assigned a higher weight than operational risks for version management of electronic documents) and rᵢ is the risk score for each dimension, calculated using real-time performance data and historical records.

This aggregation allows the algorithm to produce an overall score that quantifies the electronic document's risk exposure, providing a clear metric for comparison across electronic documents or scenarios.

The MDRCO algorithm may also include a control optimization algorithm that calculates the control efficiency index (CEI) for each electronic document, which measures how effectively the electronic document's controls mitigate associated risks:

$$CEI = \frac{Mitigated Risks}{Total Risks}$$

where the Mitigated Risks represent the decrease in the aggregated risk score (RRR) after applying specific controls, and the Total Risks represent the resources required to implement and maintain the controls. By analyzing the CEI, the algorithm ensures that electronic documents are optimized to address high-risk dimensions first while minimizing resource consumption. Controls with low efficiency are flagged for adjustment or replacement, enabling organizations to allocate resources more effectively. For example, in the context of cybersecurity and IT controls, the MDRCO algorithm may optimize network access and firewall rules to ensure efficient resource allocation while maintaining security. Consider an enterprise network where access to critical internal systems (e.g., databases, production servers) is restricted to on-site connections for security reasons, preventing external access. The organization enforces strict firewall rules and multi-factor authentication for privileged users, reducing regulatory and operational risks.

One of the standout features of the MDRCO algorithm is its use of a Bayesian inference model to predict how changes in control elements affect risk scores and benefits. By leveraging probabilistic reasoning, the algorithm analyzes historical data, real-time performance metrics, and simulated scenarios to generate predictions about the impact of specific control adjustments. For example, introducing an automated compliance monitoring system might lower regulatory risk but increase operational costs. The Bayesian model evaluates the trade-offs and suggests optimal adjustments to maximize overall benefit.

The algorithm considers multiple risk dimensions simultaneously, ensuring that the electronic documents are evaluated comprehensively. In addition, by incorporating real-time data and Bayesian inference, the algorithm provides actionable insights for refining electronic documents and controls. Further, CEI calculations ensure that resources are allocated to controls that deliver the greatest risk reduction impact. Moreover, the algorithm identifies vulnerabilities, gaps and inefficiencies in the electronic documents, enabling organizations to address them before they escalate. Therefore, the MDRCO algorithm represents a breakthrough in electronic document evaluation and optimization, providing a systematic, multi-dimensional approach to risk and control management. By combining weighted risk aggregation, control efficiency analysis, and Bayesian inference, this algorithm empowers organizations to navigate complex regulatory and operational landscapes with precision and confidence. Through its dynamic and data-driven methodology, MDRCO ensures that electronic documents at the organizational level remain effective, efficient, and aligned with strategic goals.

In some embodiments, the ADA 140 may also integrate anomaly detection capabilities. For example, by employing techniques like spectral analysis and graph clustering, when dynamically scanning contents associated with the electronic documents, the ADA 140 may identify unusual patterns, such as electronic document conflicts, redundant controls, or overlooked risks. This ensures that the propagation of risks does not amplify existing inconsistencies in the electronic document framework. In some embodiments, the RDA is configured for scalability, handling vast and complex networks of electronic documents, risks, and controls with minimal computational overhead. For example, in the context of scaling anomaly detection in large enterprise networks, the ADA 140 minimizes computational overhead by applying spectral analysis and graph clustering selectively, rather than performing exhaustive scans across all electronic documents. Consider a multinational organization managing hundreds of interconnected electronic documents, risk controls, and compliance frameworks across multiple business units. If a traditional static approach were used, anomaly detection may require continuous full-network scans, leading to significant computational costs due to redundant processing.

To optimize scalability, the ADA 140 may dynamically prioritize anomaly detection based on real-time triggers and dependencies. For instance, if a new regulatory requirement impacts financial reporting controls, the system identifies only the relevant document clusters (e.g., revenue recognition, tax-relevant documents) rather than scanning the entire compliance framework. Similarly, if a graph-based propagation model detects a high-impact content change, the ADA 140 focuses computational resources on the most affected nodes, rather than reprocessing unrelated controls. This selective and hierarchical anomaly detection approach significantly reduces processing load, allowing the system to handle vast and complex electronic document networks while ensuring risk propagation does not amplify inconsistencies.

In some embodiments, to ensure relevance and accuracy, the ADA 104 may further incorporate dynamic recalibration, which continuously adjusts its benchmarks and recommendations based on three primary data sources. First, it ingests updates from regulatory databases, dynamically crawling and parsing new regulations to incorporate emerging requirements. Second, the algorithm integrates real-time organizational performance metrics through API connections, enabling it to adapt its evaluations to the current operational landscape. Further, the ADA 104 employs a feedback loop that analyzes historical electronic document outcomes, learning from past successes and failures to improve future recommendations.

In some embodiments, the ADA 104 may further include an ARL mechanism 110. The ARL framework is an intelligent system designed to continuously refine electronic documents by leveraging context-aware reinforcement learning techniques. Through autonomous learning, the ARL framework enables the automated created electronic documents to dynamically adapt to changing regulatory requirements, organizational priorities, and operational risks. This capability ensures that the automated created electronic documents remain effective, compliant, and optimized for long-term organizational goals after creation, even in rapidly evolving environments.

In some embodiments, the ARL framework may operate through an electronic document agent network, where each electronic document is represented by an independent reinforcement learning (RL) agent. Each agent is autonomous and tasked with exploring different configurations of controls associated with its respective electronic document. These agents interact with their environment, which includes real-time data on risks, operational metrics, and organizational constraints. By simulating and testing various control strategies, the agents learn which configurations produce optimal outcomes. For example, an agent managing a data privacy electronic document may experiment with different encryption standards or access control methods to enhance compliance with data protection laws.

A central element of the ARL framework is its reward function, which guides the learning process of each RL agent. The reward function evaluates electronic document performance based on three exemplary critical dimensions:
Lower Risk Scores: A gents are rewarded for minimizing risks, such as regulatory violations, operational inefficiencies, or certain cybersecurity related losses.
Higher Control Efficiency Index (CEI): The reward increases when agents identify controls that achieve the maximum risk reduction with the least resource expenditure. This ensures that resource efficiency is prioritized.
Improved Electronic Document Benefits: Additional rewards are given for enhancing measurable electronic document outcomes, such as improved computation resources efficiency, cybersecurity, compliance, or operational efficiency.

By balancing these metrics, the reward function ensures that agents optimize electronic documents in a holistic manner, addressing both risks and benefits while considering resource constraints.

In some embodiments, the training of electronic document agents may be conducted through a multi-armed bandit (MAB) framework, which combines exploration (trying new strategies) with exploitation (leveraging known successful strategies). The training process includes:
Historical Data Utilization: A gents learn from past electronic document outcomes, using historical data to understand the effectiveness of previous actions and control configurations.
Simulated Scenarios: A gents are trained on simulated scenarios, such as hypothetical regulatory changes or unexpected operational risks, to prepare for real-world challenges.
Iterative Learning: Over time, agents refine their strategies by continuously analyzing feedback from their actions and adapting their strategies to achieve better results.
   For instance, an agent responsible for electronic document compliance may train on scenarios involving new data protection regulations, learning how best to adjust controls to maintain compliance while minimizing resource use.

The ARL framework represents a groundbreaking approach to electronic document refinement, providing organizations with a system that evolves their electronic documents through continuous, data-driven learning. By utilizing autonomous RL agents, a robust reward function, and an advanced training process, ARL ensures that the created electronic documents update/adapt dynamically to meet organizational goals, regulatory demands, and operational challenges. This intelligent and proactive methodology empowers organizations to maintain resilience, compliance, and efficiency in an ever-changing environment.

In summary, the ADA 104 represents a groundbreaking advancement in electronic document benchmarking. Its integration of high-dimensional feature space mapping, multi-agent reinforcement learning, and dynamic recalibration enables it to operate as a self-evolving compliance engine. By providing real-time, multi-dimensional insights, the ADA 104 empowers organizations to navigate complex compliance landscapes with unparalleled precision and efficiency.

Referring continuously to FIG. 1A, GCE 106 is an advanced AI-driven module designed to revolutionize electronic document processing by synthesizing, validating, and simulating organizational documents in real time. Its primary goal is to ensure that the created electronic documents align with evolving legal requirements, regulatory frameworks, and organizational priorities, while proactively addressing potential risks. By leveraging generative artificial intelligence techniques, such as transformer-based models or diffusion models, the GCE 106 may introduce a dynamic, forward-looking approach to electronic document creation and compliance validation.

One of the core functions of the GCE 106 is electronic document simulation, where it generates and evaluates the outcomes of electronic documents under various scenarios. For example, the GCE 106 may model the impact of new regulations or organizational changes on existing electronic documents, helping relevant entities assess risks and identify areas of improvement before implementation. This simulation capability is particularly valuable for stress-testing documents against edge cases, such as rare regulatory events or high-risk operational scenarios.

In some embodiments, the GCE 106 may include a simulation and scenario analysis module to evaluate the potential impacts of electronic document changes before they are implemented. By leveraging advanced simulation techniques, such as Monte Carlo simulations and generative adversarial networks (GANs), this module provides organizations with a powerful tool for stress-testing documents and ensuring they are robust across a wide range of conditions. The module enables data-driven decision-making by identifying risks, quantifying their impacts, and providing actionable insights to refine electronic documents proactively.

Specifically, for Monte Carlo simulations, thousands of potential scenarios may be generated to evaluate how a system responds under varying conditions. These scenarios might include events such as a cyber breach, a sudden regulatory change, or operational disruptions. By simulating these events across a range of probabilities and severities, the GCE 106 may calculate the likely outcomes and risks associated with a particular electronic document implementation. For example, when testing a new data privacy electronic document, the simulation might evaluate the electronic document's resilience under different types of data breaches, identifying potential vulnerabilities and estimating compliance risks. Monte Carlo simulations provide quantitative insights into how document-derived implementations perform under both expected and extreme conditions, enabling organizations to anticipate challenges and optimize their controls.

In some embodiments, to address the challenge of modeling rare but high-impact events, the GCE 106 may integrate GANs. GANs are a type of machine learning model that creates synthetic data resembling real-world scenarios. This capability is particularly valuable for generating edge cases, such as a once-in-a-decade regulatory overhaul or a catastrophic cybersecurity breach. By training GANs on historical data and known risk patterns, the GCE 106 may produce realistic but novel scenarios that stress-test electronic documents against unforeseen challenges. For instance, a GAN may simulate a sophisticated ransomware attack targeting multiple departments simultaneously, providing critical insights into how an organization's electronic documents would provide guidelines to hold up under such conditions.

In some embodiments, the combination of Monte Carlo simulations and GANs allows the GCE 106 to assess both the breadth of electronic document performance (across common scenarios) and the depth of resilience (under extreme or unexpected events). This dual capability ensures that organizations are prepared not only for routine challenges but also for rare crises that could have disproportionate impacts. Moreover, the GCE 106 may support continuous electronic document refinement by providing a feedback loop: insights from simulations are used to adjust parameters/features in electronic documents, strengthen controls, and optimize resource allocation, as will be described in detail later.

Another critical capability of the GCE 106 is compliance validation. Unlike traditional static tools that rely solely on rule-checking, the GCE 106 may combine symbolic AI (logic-based frameworks) with generative AI techniques to validate electronic documents. It evaluates proposed electronic documents against complex legal texts, industry standards, and organizational guidelines to ensure alignment and feasibility. By continuously ingesting updates from regulatory APIs and databases, the GCE 106 may stay up-to-date with legal changes, reducing the risk of non-compliance.

The GCE 106 is also configured for synthetic electronic document drafting, where it may generate new electronic document drafts by combining existing organizational documents with regulatory requirements and internal guidelines, governance frameworks, operational mandates, and compliance protocols. This function enables organizations to automatically create future-proof electronic documents that adapt to anticipated challenges and opportunities. The engine uses natural language generation techniques to produce human-readable electronic document drafts, ensuring linguistic coherence, regulatory alignment, and contextual accuracy, clarity and precision.

Unlike conventional compliance systems, the GCE 106 may operate as a dynamic, self-evolving engine. It integrates seamlessly with tools like graph ecosystems and adaptive learning algorithms to provide a closed-loop system for continuous improvement. By predicting regulatory trends, adapting to real-time data, and automating electronic document updates, the GCE 106 may empower organizations to navigate complex compliance landscapes with efficiency and confidence.

In some embodiments, the GCE 106 may further include contextual embeddings for regulation and control (CERC) module configured to ensure that organizational electronic documents align with ever-changing regulations and evolving operational priorities. By leveraging cutting-edge natural language processing (NLP) techniques and context-matching algorithms, the CERC module may enable a deep understanding of complex regulatory requirements and their seamless integration into existing electronic document frameworks.

At the heart of the CERC module is its use of bidirectional encoder representations from transformers (BERT)-like embeddings, which are designed to parse and analyze regulatory texts with exceptional precision. These embeddings may capture both the semantic and syntactic nuances of regulatory language, allowing the system to extract relevant clauses and controls from complex legal and financial documents. For example, when analyzing the general data protection regulation (GDPR), the module may identify specific provisions that impact data privacy electronic documents, such as encryption standards or data access controls. This capability may ensure that organizations can quickly and accurately interpret regulatory requirements and map them to their internal processes and document content.

In some embodiments, the CERC module may also employ semantic similarity algorithms to map regulatory requirements to specific electronic document nodes within the system's electronic document graph. By evaluating the contextual alignment between regulatory texts and electronic document content, the module may ensure that each electronic document is updated to reflect the latest legal and operational requirements. For instance, if a new regulation mandates enhanced employee data protection measures, the module identifies the relevant IT electronic documents and highlights necessary updates. This automated mapping process not only reduces manual effort but also ensures that electronic document updates are comprehensive and compliant.

In some embodiments, the CERC module is configured to perform continuous updates. The module may automatically ingest regulatory changes and updates from APIs, industry standards, and organizational performance metrics. This real-time data integration may allow the module to refine its embeddings and adjust electronic document recommendations dynamically. For example, when a regulatory authority releases a new cybersecurity framework, the module processes the update, evaluates its impact on existing electronic documents with organizations, and generates actionable recommendations for alignment or even automatically updates the electronic documents. This capability ensures that organizations remain compliant in an ever-changing regulatory environment while minimizing the risk of oversight.

The CERC Module is a transformative tool that bridges the gap between complex regulatory requirements and actionable electronic document processing. By combining advanced NLP, semantic context-matching, and real-time updates, the module provides organizations with a proactive, intelligent system for maintaining compliance and operational alignment.

In some embodiments, the graph-based electronic document processing platform or system 100 may include additional components not described above. For example, the graph-based electronic document processing platform or system 100 and/or the generative compliance engine (GCE) 106 may additionally include elements or components specifically configured for electronic document creation and update, which is integrated into the above electronic document graph ecosystem. For example, when creating or updating an electronic document by the elements/processes described below, the electronic document graph ecosystem may evaluate and/or further refine the created or updated electronic document. In some embodiments, the disclosed graph-based electronic document processing platform or system 100 may further include query handling components and feedback collection tools, among many other components that together implement the dynamic electronic document creation and update in complicated environments, as further described in detail below.

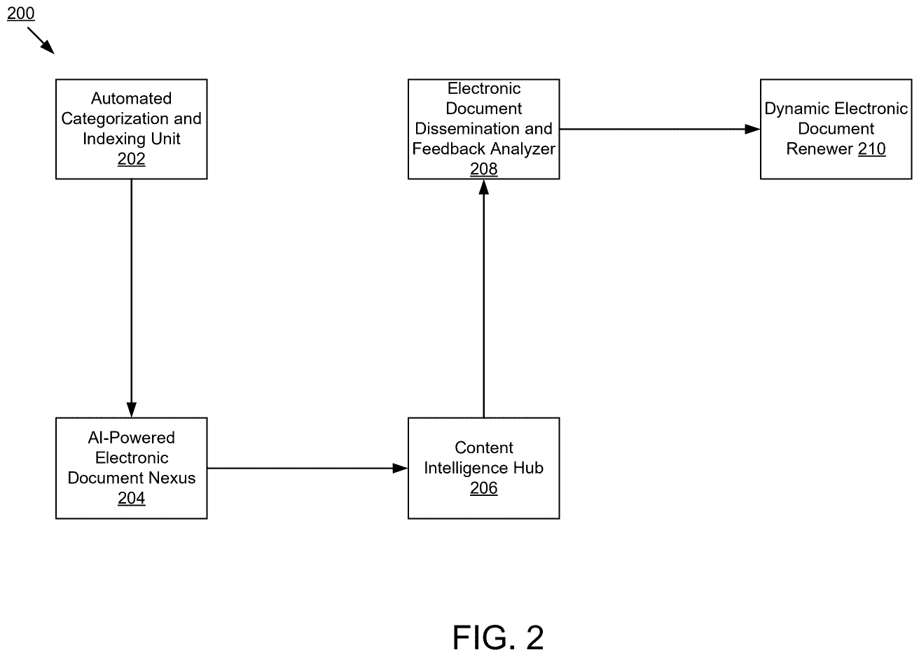

Referring now to FIG. 2, an example flow diagram 200 of the disclosed graph-based electronic document processing system 100 is provided, according to embodiments of the disclosure. As illustrated, the platform may include an automated categorization and indexing unit 202, an AI-powered electronic document nexus 204, a content intelligence hub 206, an electronic document dissemination and feedback analyzer 208, and a dynamic electronic document renewer 210. It should be noted that these various components may be integrated into or may be specific implementation components included in the components 102-110 illustrated in FIG. 1A. In the following descriptions, each component 202-210 is described with reference to their specific functions in the graph-based electronic document processing without necessarily referring back to their relations to the components 102-110 described above.

The automated categorization and indexing unit 202 serves as the initial entry point for the system, responsible for processing, categorizing, and indexing electronic document-related data. It collects data from various sources, including internal repositories, regulatory databases, and industry benchmarks, uses machine learning (M L) models to classify data based on factors like risk category (e.g., regulatory, cybersecurity, environmental, ESG) and compliance domain (e.g., GDPR), and organizes data into a searchable database using tools like Elasticsearch®, enabling fast and efficient retrieval for downstream processes. In some embodiments, the automated categorization and indexing unit 202 may use NLP models for content classification and search indexing tools such as Apache Lucene, and Elasticsearch® for indexing.

As the central intelligence of the system, the AI-powered electronic document nexus 204 generates, evaluates, and benchmarks electronic documents. It leverages NLP models to autonomously draft electronic documents based on organizational needs, regulatory standards, and industry benchmarks, compares existing electronic documents against regulatory requirements and provides alignment scores, and measures electronic document maturity and compliance against industry best practices, highlighting gaps and recommending improvements. In some embodiments, the AI-powered electronic document nexus 204 may use transformer-based NLP models like a generative pre-trained transformer (GPT) or BERT for semantic analysis, and use machine learning models for benchmarking and gap analysis.

The content intelligence hub 206 focuses on risk categorization, bias elimination, and actionable insights for electronic document refinement. It automatically identifies risks in electronic documents, such as ambiguous language or non-compliance, and categorizes them by severity, detects and corrects biases in electronic document content to ensure fairness and inclusivity, and provides precise recommendations for content adjustments, enhancing clarity, alignment, and risk mitigation. In some embodiments, the content intelligence hub 206 may use sentiment analysis and named entity recognition (NER) for detecting biases and risks, and may use continuous learning algorithms to improve contextual understanding and suggestions.

The electronic document dissemination and feedback analyzer 208 ensures effective communication of electronic documents to relevant entities while analyzing their feedback for continuous improvement. It delivers electronic documents to relevant entities using multiple channels (e.g., email, Slack®, dashboards), captures input through surveys, quizzes, and acknowledgment logs, and uses sentiment analysis and engagement metrics to identify areas where electronic documents or their communication can be improved. In some embodiments, the electronic document dissemination and feedback analyzer 208 may use feedback collection tools integrated with APIs (e.g., Google® Forms, Typeform®) for feedback collection and use analytics engines for processing feedback trends and engagement metrics.

The dynamic electronic document renewer 210 ensures electronic documents remain up-to-date by dynamically adapting them to regulatory changes and organizational shifts. It tracks updates from regulatory bodies and changes in organizational structures, automatically modifies electronic documents to align with new standards or internal requirements, and assesses the effects of changes on existing electronic documents and generates detailed update reports. In some embodiments, the dynamic electronic document renewer 210 may use event-driven systems (e.g., Apache® Kafka) for real-time monitoring and use rule-based engines (e.g., open electronic document agent) for compliance evaluation.

In some embodiments, the various components 202-210 described above may be organized into a modular architecture, ensuring scalability, flexibility, and reliability. For example, the modular architecture for the disclosed graph-based electronic document processing platform may include a data integration layer for collecting data from various sources, such as APIs, databases, and web scrapers, a data storage and management unit for centralizing and managing data for electronic document analysis, an AI ingestion layer for analyzing, generating, and evaluating electronic documents, a real-time monitoring layer for tracking electronic document adherence and regulatory changes, an automation and workflow engine to automate updates and corrective actions, and multiple different user interfaces to enable interaction and visualization. In some embodiments, these various modular components may further include additional sub-components, as further described in detail in FIGS. 2-7.

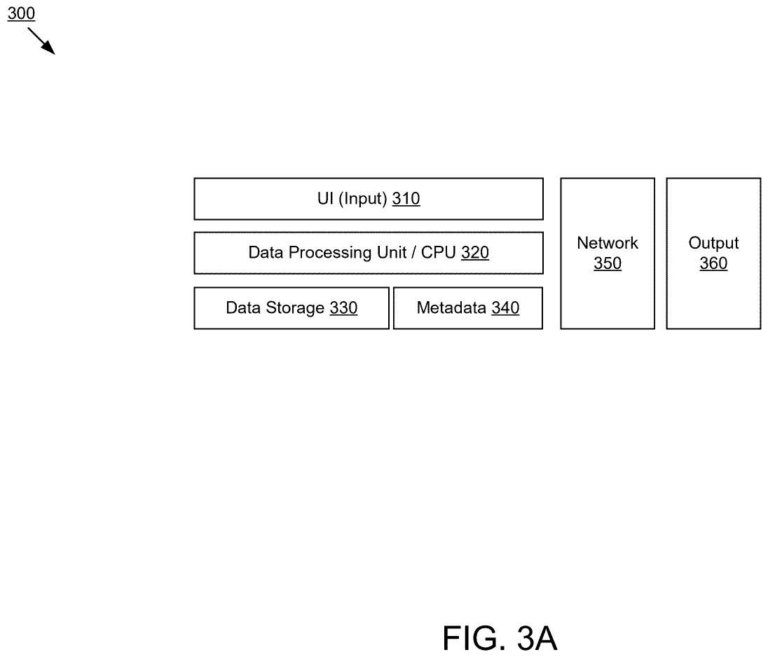

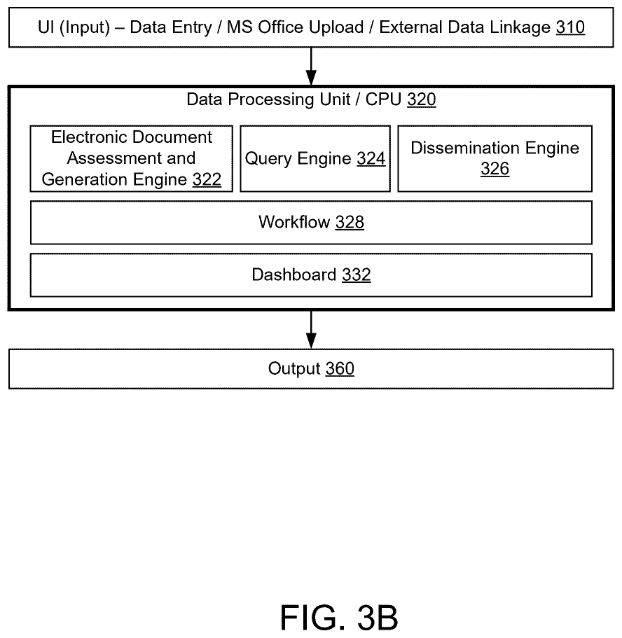

FIG. 3A illustrates an overall architecture 300 of the disclosed graph-based electronic document processing system 100, according to embodiments of the disclosure. As illustrated, the disclosed architecture 300 includes a UI (input) unit 310, a data processing unit/CPU 320, a data storage unit 330, metadata 340, a network device 350, and an output unit 360.

The UI (input) unit 310 serves as the gateway for collecting data and user inputs into the system 100. According to some embodiments, the UI (input) unit 310 receives data from multiple sources, including regulatory databases and organizational repositories, and the like. The UI (input) unit 310 also accepts user inputs such as queries, electronic document drafts or edits, or feedback through various interfaces like web portals, APIs, file uploads, and so on. Diverse data formats, including text, structured data (JSON, XML), and unstructured documents (PDF, Word) may be collected by the UI (input) unit 310.

The data processing unit 320 processes raw input data into meaningful insights by applying algorithms, analytics, and transformations. According to some embodiments, the data processing unit 320 parses and normalizes input data for consistency and usability, performs operations like NLP, sentiment analysis, and metadata extraction, and executes advanced analytics, including risk categorization, compliance checks, and electronic document benchmarking. The specific functions of the data processing unit 320 are further described in detail in FIGS. 3B-7.

The data storage unit 330 is responsible for securely storing collected raw data and processed data for retrieval and analysis. According to some embodiments, the data storage unit 330 organizes data in structured and unstructured formats, enabling efficient querying. The data storage unit 330 also maintains historical data for version control, audit trails, and trend analysis, and supports indexing for faster search and retrieval.

The metadata 340 enriches the stored data with additional context, improving its usability and relevance. For example, the metadata may tag data with descriptive information, such as source, timestamp, category, jurisdiction, and version, thereby enabling advanced filtering and searching using metadata attributes, and supporting compliance mapping by linking electronic documents to regulatory frameworks and industry benchmarks.

The network device 350 facilitates communication and data exchange between the platform's components and external sources. For example, the network device 350 may connect to external regulatory databases, industry benchmarks, and organizational systems via APIs or data streams. In some embodiments, the network device 350 may support secure data transmission using encryption protocols (e.g., TLS/SSL), and handle network traffic to ensure seamless integration and communication between modules.

The output unit 360 delivers processed data, insights, and actionable recommendations to relevant entities. Exemplary outputs include but are not limited to electronic document drafts/edits, risk assessments, compliance reports, and benchmark comparisons. The output unit 360 also provides visualizations like dashboards, charts, and heatmaps for data-driven decision-making. In some embodiments, multiple output channels, including email notifications, entity-specific portals, and downloadable reports may be supported by the output unit 360.

FIG. 3B illustrates example components included in a data processing unit 320, according to some embodiments of the disclosure. As illustrated, the data processing unit 320 may be a CPU unit or a core unit of the disclosed graph-based electronic document processing system 100, which further includes an electronic document assessment and generation engine 322, a query engine 324, a dissemination engine 326, a workflow 328, and a dashboard 332.

The electronic document assessment and generation engine 322 may be a blend of AI, rule-based engine and template-driven automation. According to one embodiment, the core function of the electronic document assessment and generation engine 322 is its electronic document assessment and electronic document generation capacity. For electronic document assessment, the electronic document assessment and generation engine 322 may analyze existing electronic documents for compliance, effectiveness, and risks, and identify gaps or areas for improvement based on regulatory standards, industry benchmarks, and organizational goals. For electronic document generation, the electronic document assessment and generation engine 322 may automatically create new electronic documents tailored to specific requirements, including using NLP models to draft electronic documents that align with predefined templates and regulations.

According to one embodiment, the electronic document assessment and generation engine 322 may include an input layer configured to accept existing electronic documents, organizational goals, and regulatory requirements as input, where these inputs may be in the forms of PDFs, Word documents, JSON, or structured databases. For electronic document assessment, the electronic document assessment and generation engine 322 may use NLP models to analyze the language and structure of the electronic documents and use rule-based engines to evaluate compliance and effectiveness. For electronic document generation, the electronic document assessment and generation engine 322 may be configured to combine AI-driven text generation (GPT, BERT) with predefined templates. The electronic document assessment and generation engine 322 may customize the electronic document generation based on industry and organizational context.

According to one embodiment, the specific technologies for electronic document assessment may include but are not limited to NLP libraries (e.g., Hugging Face® transformers, spaCy® for text parsing, etc.), rule engines (e.g., Drools®, open electronic document agent (OPA), etc.), and compliance libraries (e.g., industry-specific tools (e.g., health insurance portability and accountability act (HIPAA) toolkit, ISO compliance tools)). The specific technologies for electronic document generation may include but are not limited to NLP models (e.g., GPT-4® for text generation, fine-tuned on electronic document-specific datasets) and the template engines (e.g., Jinja2 for dynamic text insertion into predefined electronic document structures).

According to one embodiment, to assess an electronic document, text preprocessing may be first performed to tokenize, normalize, and extract key electronic document components (e.g., objectives, scope, compliance clauses) of an electronic document. To evaluate the electronic document, evaluation criteria are further defined in a rule engine (e.g., Drools®), which is then used to evaluate the electronic document. In some embodiments, the risk and gap are further analyzed, which includes using ML models for clustering similar electronic documents and detecting gaps, which can be visualized using tools like M atplotlib or D3.js.

To generate an electronic document, an electronic document template may be first generated. For this reason, there may be modular templates, with placeholders for AI-generated text, created at first. GPT models may be then trained or fine-tuned on domain-specific electronic document datasets. Thereafter, organizational context may be integrated using prompts (e.g., company goals, risk tolerance) to generate organizational electronic documents.

According to one embodiment, a generated electronic document is further evaluated. For example, the system may allow relevant entities to annotate electronic documents and suggest improvements, which may be further analyzed using sentiment analysis to gauge the tone and effectiveness of the generated electronic documents. In some embodiments, reinforcement learning with human feedback (RLHF) may be used to improve the quality of the generated electronic documents. In some embodiments, certain fine-tune models may be used to fine-tune generated electronic documents using updated datasets.

Referring back to FIG. 3B, the query engine 324 may be configured to parse user input (keywords, natural language, or structured queries) and execute queries on data using both lexical and semantic search. In some embodiments, the data including all electronic documents may be indexed for efficient querying. In some embodiments, the query results may be ranked based on relevance, compliance impact, or recency.

Specifically, all electronic documents may be converted into a structured format like JSON or XM®. In addition, metadata (e.g., title, date, compliance standards) may be extracted. Next, the electronic documents are indexed. Thereafter, NLP models are used for advanced semantic understanding. For example, sentence transformers may be used for semantic understanding.

The dissemination engine 326 may be configured to automatically deliver relevant electronic document updates to relevant entities. This enables personalized notifications based on roles, interests, or past queries. For example, the dissemination engine 326 may generate alerts based on electronic document changes or compliance deadlines through pub/sub systems like RabbitMQ® or AWS® SNS, send electronic document updates to relevant entities through emails, provide endpoints for external systems to fetch updates, or integrate with Slack®, Microsoft® Teams, or WhatsApp®. It will also be used to track buy-in from respective entities and confirm awareness of changes.

Additionally, the dissemination engine 326 may autonomously orchestrate an educational campaign for respective entities regarding document content. It may solicit feedback, conduct sentiment analysis on the responses, and assess buy-in and adoption levels to determine engagement of respective entities. Based on this analysis, the system may generate targeted learning modules or document explanations tailored to user roles and previous interactions, ensuring context-aware knowledge dissemination. In some embodiments, the dissemination engine 326 may further apply adaptive content delivery techniques, such as progressive information rollouts or interactive guidance, to drive deeper content understanding. The dissemination engine 326 may also identify resistance patterns or gaps in content-driven adoption, leveraging AI-driven insights to suggest actionable recommendations and risk mitigation plans. These insights facilitate automated refinement of electronic documents or entity-specific interventions, ensuring alignment with compliance goals while improving organizational readiness and effectiveness of electronic documents.

According to some embodiments, the dissemination engine 326 may use comparison tools (diff or version control) to detect electronic document updates, and generate notifications when changes are significant. In some embodiments, templates may be used for standardized communication in dissemination. In some embodiments, AWS® Lambda may be used for query handling and notification processing.

Workflow 328 may be configured to manage various tasks related to the electronic document lifecycle. For example, workflow 328 may be configured to monitor electronic document drafting, review, approval, dissemination, monitoring, and updates. In some embodiments, the workflow 328 may monitor only a portion of the electronic document lifecycle. For example, the workflow may include a first workflow to monitor electronic document assessment and a second workflow to monitor electronic document dissemination. For the electronic document assessment workflow, it may include inputting electronic documents, analyzing for compliance, identifying risks, and generating recommendations. For the electronic document dissemination workflow, it may include detecting electronic document updates, generating notifications, distributing through channels, and collecting feedback.

In some embodiments, there may be workflow engines configured to monitor the various workflows. Example workflow engines may include but are not limited to Apache® Airflow, Camunda®, or Zeebe®. There may also be task orchestration tools for orchestrating the tasks included in a workflow. Example task orchestration tools may include but are not limited to Perfect® or AWS® Step Function.

Here the following is a workflow example for electronic document lifecycle management. The workflow starts with drafting an electronic document. For example, a user may upload (through an uploading tool) or draft an electronic document via the dashboard. The upload may trigger an NLP-based assessment in the backend. The workflow then proceeds to review and approval. For example, notifications may be sent to the reviewers for comments. The workflow then tracks reviewer feedback and approval. Once approved, the workflow then proceeds to dissemination. For example, the approved electronic documents may be sent to relevant entities via email or Slack®. After the dissemination, the workflow may proceed to the monitoring stage of the lifecycle of the electronic document. For example, real-time compliance tracking may be performed through connected monitoring tools. If there are any changes, the workflow may then proceed to the updating stage, where certain regulatory changes may trigger auto-updates or require user intervention.

In some embodiments, the tasks (e.g., draft, review, and approve) included in a workflow may be represented by nodes in a workflow visualization. Directed edges may represent dependencies among the linked nodes.

Dashboard 332 may be configured to display various components described above. For example, the dashboard may include a high-level summary, which includes total electronic documents, pending reviews, compliance status, and recent updates. The high-level summary may be organized in different formats, such as pie charts (e.g., electronic document categories) and line graphs (e.g., compliance trends). For electronic document creation and management, the dashboard may also include an interface for drafting/editing or uploading electronic documents, and for displaying real-time feedback, such as risk indicators and compliance scores. For electronic document dissemination, the dashboard 332 may include notification logs, such as sent emails, Slack® messages, or alerts. In addition, the dashboard 332 also includes feedback collection, such as comments or engagement metrics. For compliance monitoring, the dashboard 332 may include an alert center for displaying notifications for deviations or risks. The dashboard 332 may also include metrics related to compliance monitoring, such as compliance percentage, regulatory alignment, and risk levels. In some embodiments, the dashboard 332 may also include components related to the search and query. For example, the dashboard may include one or more advanced search bars for keyword and semantic search. In some embodiments, certain filters may be added to allow to search by date, category, compliance, entity group, etc.

In some embodiments, based on the different roles, different dashboards may be presented. For example, for an administrator, the generated dashboard 332 may allow him/her to view all workflows, edit electronic documents, and assign tasks. For a reviewer, the generated dashboard 332 may allow him/her to provide feedback and approve/reject electronic documents.

In one example embodiment, the dashboard 332 may include a header, a footer, a sidebar, a main panel, one or more detailed panels, etc. The header may include a navigation menu for navigating electronic documents, assessments, notifications, reports, etc. In some embodiments, the header may also include a search bar for quick access to specific electronic documents and topics. The main panel may include overview cards for reviewing total electronic documents, pending reviews, compliance status, etc. In some embodiments, the main panel may further include graphs for presenting trends in electronic document updates, compliance rates, etc. The sidebar may include a workflow tracker for viewing current tasks (e.g., pending approvals) as well as certain quick links to access frequently used features. The detailed panels may include an electronic document list, which may be a table view of electronic documents with filters and status indicators. In some embodiments, the detail panels may further include a compliance dashboard to highlight alerts and deviations. The footer may include contact support, help documentation links, etc.

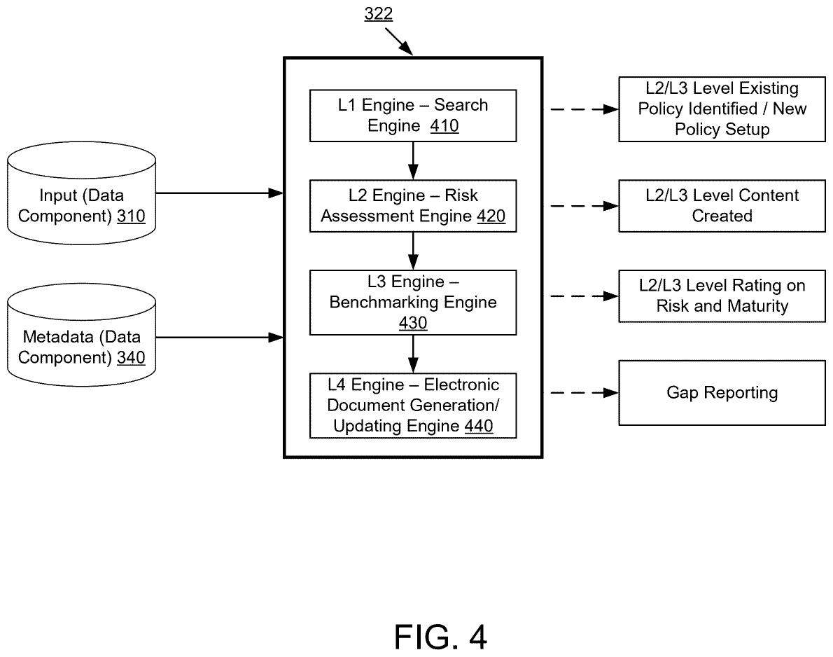

FIG. 4 illustrates example components included in an electronic document assessment and generation engine 322, according to embodiments of the disclosure. As illustrated, the electronic document assessment and generation engine 322 may specifically include a search engine 410, a risk assessment module 420, a benchmarking engine 430, and an electronic document generation/updating engine 440. In FIG. 4, each engine is marked with a specific level, such as level 1 (L1) to level 4 (L4) for differentiation purposes when there are certain outputs generated through these engines (as indicated by the dotted arrows in FIG. 4 and in other figures). For example, existing electronic documents may be identified and new electronic documents may be set up through the L2/L3 engines, content may be created through L2/L3 engines, risk and maturity rating may be obtained through L2/L3 engines, etc.

The search engine 410 may be configured to locate existing electronic documents within an organization, identify external electronic documents or templates for setting up new electronic documents, and support advanced searches for specific electronic document elements (e.g., compliance standards). The search engine 410 may implement keyword and semantic search to identify electronic documents based on user input or concepts and may search by predefined filters such as risk level, compliance standards, maturity level, or organizational unit. In some embodiments, the search engine 410 may suggest relevant external electronic documents from databases or public repositories.

The search engine 410 may use certain text search tools, such as Elasticsearch® and Apache® Solr for keyword-based retrieval, semantic search tools such as Hugging Face® transformers for NLP-based queries, and external integration tools such as APIs for external repositories queries (e.g., OpenRegs, ISO standards). In some embodiments, before searching by the search engine 410, the system disclosed herein may first index electronic documents by using Elasticsearch® with metadata (e.g., tags, compliance levels). In some embodiments, the NLP embeddings may be used for semantic similarity searches. In some embodiments, the return results may be further ranked based on the relevance and maturity scores. In one example application scenario, a user enters search criteria (e.g., “GDPR compliance electronic document”). The search engine 410 then parses keywords or semantic inputs, queries internal repositories and external databases for matching electronic documents, and then displays relevant electronic documents with links, summaries, and risk or maturity scores.

The risk assessment module 420 may be configured to analyze electronic documents to assess risks, such as non-compliance, gaps, and biases, and generate actionable content for improving electronic documents based on identified risks. In some embodiments, the risk assessment module 420 may assess an electronic document based on a user selection of the specific electronic document, then use NLP to identify language risks including but not limited to vague language, inconsistencies, high-risk clauses, ambiguous terms, and non-compliant phrases. The risk assessment module 420 then assigns risk scores to evaluate the potential non-compliance areas based on factors such as regulatory requirements or operational impact. In some embodiments, the risk assessment module 420 may further suggest language modifications to mitigate risks. The NLP models used by the risk assessment module 420 may include GPT models for text analysis and spaCy® for linguistic processing. In some embodiments, preprocessing may be performed on electronic documents, such as tokenization, part-of-speech tagging, and so on. For risk scoring, a machine learning model trained on electronic document compliance datasets may be used. Alternatively, rule-based engines may be used. When reporting the risk scores or generating actionable insights, certain visualization tools may be used, such as Matplotlib or D3.js risk heatmaps, as will be described in detail later.

The benchmarking engine 430 may be configured to evaluate electronic documents against industry standards, regulations, or best practices, and assign maturity ratings based on compliance and operational efficiency. For example, the benchmarking engine 430 may compare internal electronic documents with regulatory requirements or industry benchmarks, assess electronic documents on risk exposure, clarity, enforceability, and coverage, and provide suggestions for alignment with best practices. In one example application, a user may request a benchmarking evaluation for a specific electronic document. In response to the request, the benchmarking engine 430 may compare the electronic document with regulatory or industry standards, and score the electronic document based on adherence, clarity, and maturity. Similar to the risk assessment, the benchmarking engine 430 may also generate a report with comparative scores, recommendations, and alignment levels. In some embodiments, certain datasets of standards (e.g., GDPR) may be predefined, which may be used by the benchmarking engine 430 in the comparison. In addition, certain scoring algorithms including weighted metrics for risk, maturity, and coverage may be used to calculate the comparative score. In some embodiments, dashboards with comparative scoring charts may be used for visualization.

The electronic document generation/updating engine 440 may be configured to report gaps between current electronic documents and benchmarks, and automatically draft new electronic documents or update existing ones. For example, the electronic document generation/updating engine 440 may highlight areas where electronic documents fall short of regulatory or organizational standards. The electronic document generation/updating engine 440 may then use pre-defined structures (e.g., templates) to generate new electronic documents, track electronic document updates, and maintain an audit trail when updating the existing ones. In one example application, a user may request an update or new electronic document generation. In response to the request, the electronic document generation/updating engine 440 may perform a gap analysis to identify missing components in the existing electronic document, and then draft new content based on the templates and benchmarks by using AI-generated content. The output of the electronic document generation/updating engine 440 is an updated or newly generated electronic document with a compliance report and/or detailed change logs. In some embodiments, possible template engines such as Jinja2 for structured electronic document drafting may be used by the electronic document generation/updating engine 440 in generating new electronic documents. In some embodiments, GPT models may be used to further fine-tune domain-specific electronic document generation. In some embodiments, Git® or other similar tools may be used for tracking electronic document updates.

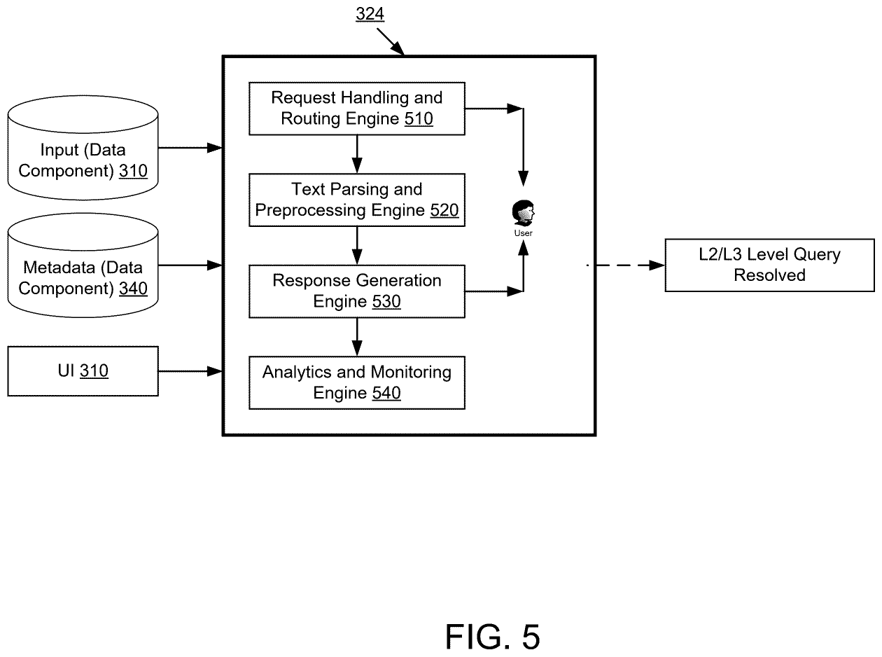

FIG. 5 illustrates example components included in the query engine 324, according to some embodiments of the disclosure. As illustrated, the query engine 324 may include a request handling and routing engine 510, a text parsing and preprocessing engine 520, a response generation engine 530, and an analytics and monitoring engine 540.

The request handling and routing engine 510 may be configured to handle incoming user queries (via web interface, APIs, or other sources) and route queries to the appropriate subcomponents for processing. The request handling and routing engine 510 may support multiple input formats (e.g., natural language queries, structured search, or filters), and may authenticate and authorize the requests for secure query handling. In some embodiments, the request handling and routing engine 510 may implement load balancing and rate limiting for high availability. In one example application, a user may submit a natural language query: “What electronic documents address data retention for GDPR compliance?” The request handling and routing engine 510 may validate input, authenticate the user, and then route the query to the text parsing and preprocessing engine 520 for further processing. In some embodiments, the API gateway used for query handling may include but is not limited to AWS® API gateway and Kong, and the load balancer used in the routing may include but is not limited to NGINX® and HA Proxy®. The authentication tool used in the process may include but is not limited to OAuth 2.0 or JWT.

The text parsing and preprocessing engine 520 may be configured to process user queries to extract intent, keywords, and contextual meaning, and convert natural language input into structured queries. The specific processes may include tokenization, lemmatization, and stop-word removal of the queries, using NER to identify elements like compliance terms or electronic document categories, and using semantic embedding generation for similarity-based matching. For example, the aforementioned query: “What electronic documents address data retention for GDPR compliance?” may be tokenized first”→[“what”, “electronic documents”, “address”, “data”, “retention”, “GDPR”, “compliance”]. Next, NER is used to identify key terms “data retention” and “GDPR compliance.” Thereafter, semantic embedding is generated for similarity matching. In some embodiments, certain NPL tools may be used by the text parsing and preprocessing engine 520 to extract key terms, such as “data retention” and “GDPR compliance” from the aforementioned user query: “What electronic documents address data retention for GDPR compliance?” The text parsing and preprocessing engine 520 may then convert the query into a structured format for database retrieval or semantic search.

The response generation engine 530 may be configured to generate results for queries by retrieving relevant documents or creating summaries, and format responses based on user preferences (e.g., detailed vs. summarized results). In some embodiments, the response generation engine 530 may implement lexical search (e.g., keyword matching) in generating the responses. For example, Elasticsearch® may be used for keyword-based retrieval. In some embodiments, the response generation engine 530 may perform a semantic search using embeddings for concept-based matching. For example, sentence transformers or OpenAI™ embeddings may be used for concept-based matching. In some embodiments, the results are re-ranked based on relevance, risk, and compliance. For example, BM 25 or a custom relevance scoring algorithm may be used for re-ranking the results.

The analytics and monitoring engine 540 may be configured to track usage patterns, performance metrics, and user feedback, monitor query success rates, and identify improvement areas for search relevance. Specifically, the analytics and monitoring engine 540 may collect query response times, error rates, and user satisfaction scores in the query result analysis. In some embodiments, the analytics and monitoring engine 540 may generate alerts for anomalies in query performance or traffic spikes.

Additionally, the analytics and monitoring engine 540 may leverage machine learning-based adaptive tuning to refine search accuracy dynamically. Using historical query data and user interactions, the system may adjust ranking models, recommend alternative search queries, or reweight indexing parameters to improve search relevance over time. The system may also incorporate context-aware anomaly detection, distinguishing between expected query fluctuations and critical performance degradation, prioritizing high-impact issues for administrators.

In some embodiments, the analytics and monitoring engine 540 may use interactive dashboards for administrators to view popular searches, search failure patterns, and emerging trends that indicate evolving compliance needs. The system may also provide automated query optimization recommendations, such as preloading high-demand query results, caching frequent lookups, or dynamically adjusting API request thresholds to balance performance and resource utilization.

Furthermore, a feedback loop may be enabled to allow users to rate query accuracy and provide feedback, which is logged for automated model retraining. This ensures continuous improvement of search algorithms, refinement of indexing strategies, and proactive adaptation to new document structures or compliance changes. The analytics insights may also be used to inform other system components, such as the dissemination engine 326 or ADA 140, ensuring query refinement aligns with broader document awareness and decision-making processes.

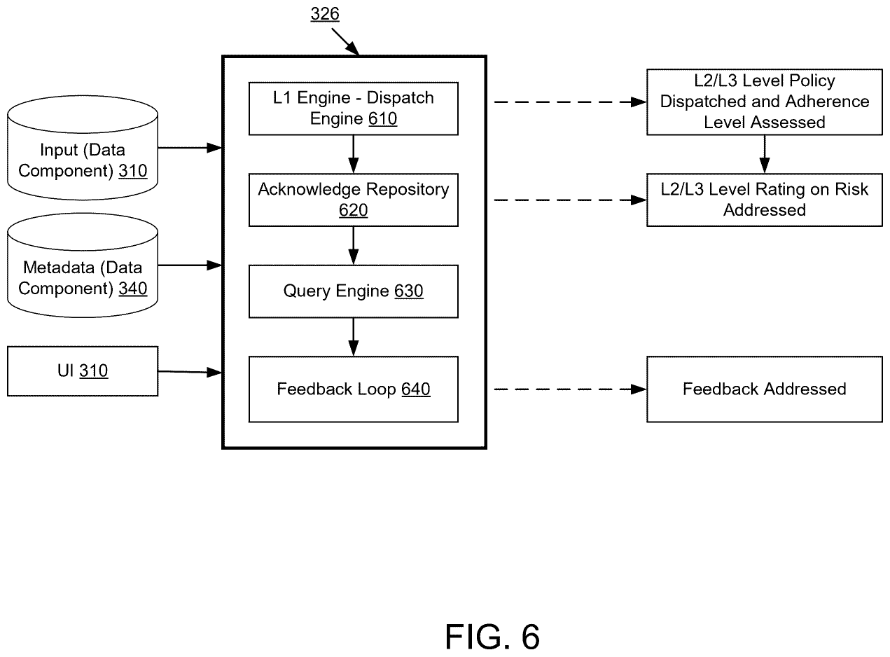

FIG. 6 illustrates example components included in the dissemination engine 326, according to some embodiments of the disclosure. As illustrated, the dissemination engine 326 may include a dispatch engine 610, an acknowledgment repository 620, a query engine 630, and a feedback loop 640.

The dispatch engine 610 may be configured to handle the distribution of electronic documents to designated entities or systems, and further track adherence levels by assessing if recipients have read, acknowledged, or implemented electronic documents. The dispatch engine 610 may implement role-based electronic document dissemination (e.g., IT team receives cybersecurity electronic documents) through multiple different channels (e.g., email, Slack®, Teams®, dashboards, etc.). For example, the dispatch engine 610 may identify target recipients based on roles, departments, or compliance needs and send the electronic documents to target recipients via preferred channels with tracking enabled. To assess adherence, the dispatch engine 610 may track or monitor recipients' actions (e.g., views, clicks, acknowledgments), and may send automated reminders for unacknowledged or pending tasks.

The acknowledgment repository 620 may serve as a centralized record of electronic document acknowledgment statuses and may maintain a compliance log for audits or tracking purposes. For example, the acknowledgment repository 620 may track acknowledgment timestamps, user details, and status (e.g., pending, completed). In some embodiments, the acknowledgment repository 620 may link acknowledgments to specific electronic document versions. In some embodiments, the acknowledgment repository 620 may generate reports for regulatory or internal audits. For example, the acknowledgment repository 620 may generate compliance reports for relevant entities. In some embodiments, the databases used for acknowledging storage may include but are not limited to PostgreSQL® or MongoDB®, while REST API may be used for accessing the acknowledgment data.

The query engine 630 may be configured to allow relevant entities to search for electronic document dispatch statuses and adherence levels. In some embodiments, advanced filters for role, department, or electronic document type may be used to facilitate the search for electronic document dispatch statuses and adherence levels. The search implemented by the query engine 630 may be an electronic document search to find electronic documents dispatched to specific recipients or teams, an adherence search to identify adherence gaps or compliance issues, or a history search to query historical dispatch and acknowledgment data. In one example, the administrator may query the system to review adherence levels by generating a query: “Show all unacknowledged GDPR compliance electronic documents for the IT department.”

In some embodiments, the query engine 630 may be configured to allow relevant entities to search for electronic document dispatch statuses, adherence levels, and compliance tracking data. In some embodiments, advanced filters based on role, department, regulatory category, risk level, or electronic document type may be used to facilitate targeted retrieval of dispatch and compliance records.

In some embodiments, the search implemented by the query engine 630 may include:
Electronic Document Search, which allows retrieval of electronic documents dispatched to specific recipients, teams, or departments and their acknowledgment status.
Adherence Search, which enables identification of adherence gaps, compliance violations, or incomplete document acknowledgments based on predefined compliance thresholds.
History Search, which allows querying of historical dispatch, acknowledgment timelines, and compliance status trends for auditing purposes.

In some embodiments, the query engine 630 may integrate natural language processing (NLP) for context-aware query interpretation, allowing administrators to formulate queries in conversational language. For example, an administrator may query the system with: “Show all unacknowledged GDPR compliance electronic documents for the IT department.”

In some embodiments, the query engine 630 may employ real-time indexing and query caching to optimize search performance, ensuring minimal computational overhead even when handling large-scale electronic document repositories. Additionally, adaptive ranking algorithms may be used to prioritize high-risk or time-sensitive compliance gaps within search results, enabling administrators to quickly identify and address urgent content adherence issues. In some embodiments, the query engine 630 may also generate automated query-based compliance reports, linking search results to risk scoring models or adherence dashboards, providing a proactive compliance monitoring framework.

The feedback loop 640 may be configured to collect feedback from relevant entities about dispatched electronic documents (e.g., clarity, relevance, implementation challenges), and use feedback to improve electronic document clarity or delivery mechanisms. For example, users can rate electronic documents, provide comments, or report issues, which can be provided to the electronic document creation team for refinements. In some embodiments, the feedback loop 640 may include an analytics engine that is configured to summarize feedback trends (e.g., common complaints or suggestions). In some embodiments, various forms such as Google® Forms, and Typeform® may be used for feedback collection. In one example application scenario, relevant entities report that a cybersecurity electronic document is too technical for general employees, the feedback loop 640 then routes the comments to the electronic document team for simplification, and the updated electronic document is re-dispatched with easier-to-understand language.

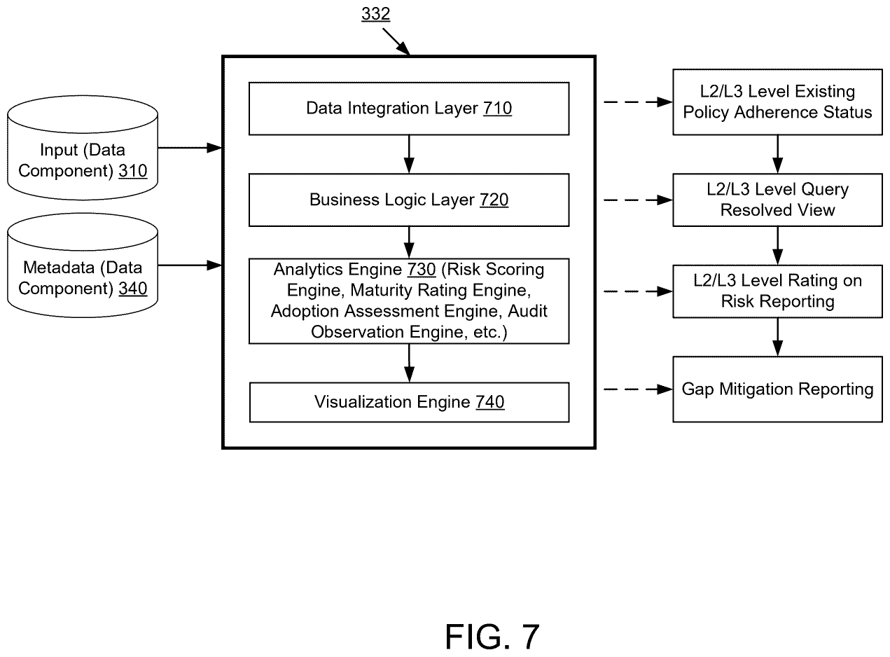

FIG. 7 illustrates example components included in the dashboard 332, according to some embodiments of the disclosure. As illustrated, the dashboard 332 architecture may include a data integration layer 710, a business logic layer 720, an analytics engine 730 (with specific engines like risk scoring, electronic document maturity, adoption assessment, and audit observation), and a visualization engine 740.

The data integration layer 710 may be configured to aggregate and normalize data from various sources to provide a unified data model. The data sources may include but are not limited to internal repositories (electronic documents, acknowledgment logs), external regulatory databases, user feedback, and adherence tracking systems. In some embodiments, the data integration layer 710 may include certain extract, transform and load (ETL) tools for data extraction and transformation, such as Apache® NiFi, Talend, or custom Python scripts. The data integration layer 710 may also include certain APIs for real-time data synchronization, such as REST/GraphQL APIs. The data integration layer 710 may also include message brokers for event-driven updates, such as Kafka® and RabbitMQ®. In some embodiments, the specific process of data aggregation by the data integration layer 710 may include: 1) connecting to internal and external data sources (e.g., compliance databases, electronic document repositories), 2) normalizing data into a common schema (e.g., metadata tagging for electronic documents: title, version, risk level, acknowledgment status), and 3) storing data in a central data warehouse (e.g., PostgreSQL®, MongoDB®, or Snowflake®).

The business logic layer 720 may be configured to define core workflows, processes, and rules for interacting with the data (e.g., adherence calculations, risk scoring formulas). For example, the business logic layer 720 may be configured for query handling (structured and unstructured data), and for transformation and routing of data for analytics and visualization. The technologies included in the business logic layer 720 may include backend frameworks such as Flask®, Django®, or Node.js® for handling API requests and data processing, and rule engines such as Drools® or open electronic document agent for business rule enforcement.

The analytics engine 730 may be configured to perform advanced analysis and compute actionable insights. For example, the analytics engine 730 may include a risk scoring engine configured to assess risks associated with electronic documents (e.g., non-compliance or operational risks), an electronic document maturity rating engine configured to measure the maturity level of electronic documents compared to industry standards or benchmarks, an adoption assessment engine configured to analyze electronic document adoption metrics, such as acknowledgment rates and adherence percentages, and an audit observation engine configured to track audit findings, map them to electronic documents, and generate compliance recommendations.

More specifically, the risk scoring engine may evaluate risks associated with electronic documents, such as regulatory gaps, non-compliance areas, and ambiguity. The input for the risk-scoring engine may include electronic document text, compliance benchmarks, and adherence data, and the output of the risk-scoring engine may include risk scores and flagged clauses. The involved technologies may include NLP models for clause analysis (e.g., Hugging Face® transformers) and scoring models such as custom Python scripts or Scikit-learn® for numerical risk scores. The electronic document maturity rating engine may rate electronic documents on a maturity scale (e.g., from “basic” to “advanced”). The input for the electronic document maturity rating engine may include industry benchmarks, completeness metrics, and adherence data, and the output of the engine may be maturity levels and recommendations. The involved technologies may include machine learning models for classification (e.g., random forest, gradient boosting), and domain-specific benchmarks stored in J SON or databases. The audit observation engine may map audit findings to electronic documents and suggest compliance actions. The input for the audit observation engine may include audit reports and an electronic document repository, and the output of the engine may include observations, flagged electronic documents, and suggested corrective actions. The involved technologies may include text parsing: spaCy® for audit text analysis and mapping logic such as predefined electronic document-to-regulation mapping rules.

The visualization engine 740 may be configured to display various content generated by the system. The technologies used by the visualization engine may include frontend frameworks such as React.js, Angular®, and Vue.js®, chart libraries such as D3.js, Chart.js, or Highcharts, and interactive dashboards such as Plotly®, Dash® or Tableau® for dynamic visualizations. The example applications of the visualization engine 740 include the generation of summary view including total electronic documents, adherence percentages, average risk scores, high-level K PIs visualized as cards or tiles, risk highlights including heatmap of high-risk electronic documents, and drill-down into specific risk factors or clauses, maturity trends including radar or bar charts comparing electronic document maturity against benchmarks, adoption metrics including line charts showing acknowledgment trends over time, and audit observations including tabular view with flagged electronic documents and recommended action.

### EXAMPLE METHODS

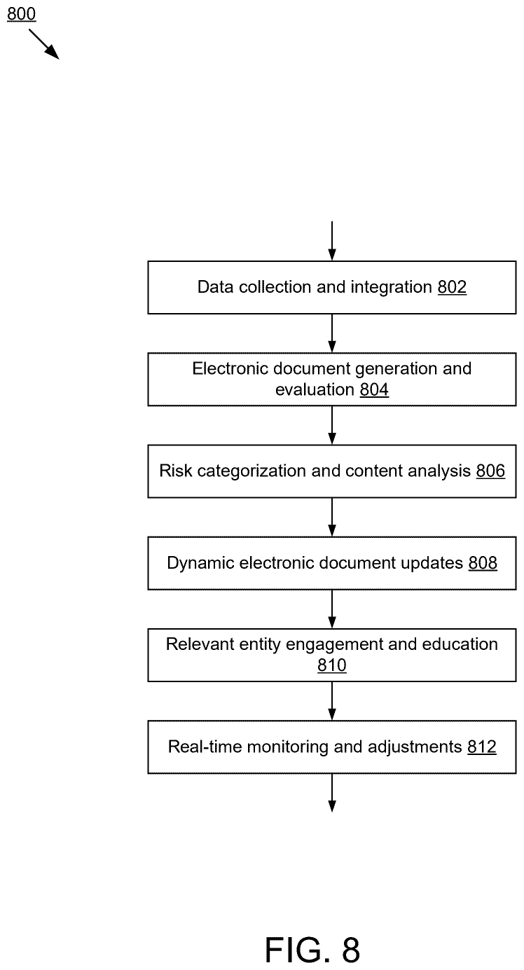

Referring now to FIG. 8, an example method 800 for electronic document benchmarking is provided. As illustrated, the method 800 for electronic document benchmarking may include data collection and integration, electronic document generation and evaluation, risk categorization and content analysis, dynamic electronic document updates, entity engagement and education, and real-time monitoring and adjustments, each of which is further described in detail below.

Specifically, the disclosed method 800 starts at step 802 with data collection and integration. Briefly, the process includes collecting data from various internal and external sources, including industry-specific databases, regulatory bodies, and organizational repositories. This data is integrated into the AI-powered electronic document nexus for comprehensive analysis and electronic document benchmarking.

Exemplarily, the system employs an advanced data integration pipeline to aggregate information from a wide range of internal and external sources, ensuring a unified and comprehensive repository for analysis within the AI-powered electronic document nexus. Internally, the system collects data from organizational repositories such as SharePoint®, Confluence®, and enterprise databases where electronic documents, adherence logs, and audit reports are stored. Electronic document processing systems and compliance tracking platforms also provide valuable data, such as acknowledgment records and adherence metrics, which are essential for understanding the implementation status associated with certain electronic documents.

Externally, the system integrates data from regulatory bodies via APIs, such as those provided by GDPR or HIPAA, to fetch updates and compliance requirements. For data that is not available through APIs, web scraping techniques are used to extract relevant announcements and regulatory changes from websites and portals. The platform also connects to industry-specific databases, such as ISO standards or national institute of standards and technology (NIST) cybersecurity frameworks, and subscribes to public feeds like RSS or OpenGov® repositories for additional benchmarks and guidelines.

Once data is collected, it undergoes a multi-step transformation process. This includes converting diverse data formats into a standardized schema, performing text extraction from PDF or Word documents using optical character recognition (OCR) tools, and enriching the data with metadata such as source, jurisdiction, and last updated timestamps. The transformed data is then stored in a centralized repository. Relational databases like PostgreSQL® are used for structured data, while data lakes such as AWS® S3 manage unstructured information, including raw audit reports and electronic document drafts. The system also leverages Elasticsearch® to index both structured and unstructured data, enabling fast and efficient keyword and semantic searches.

The integrated data feeds directly into the AI-powered electronic document nexus, where advanced machine learning algorithms and natural language processing models are applied for comprehensive analysis. For example, topic modeling algorithms map collected data to specific clauses or sections of internal electronic documents, linking external regulations with internal frameworks for direct comparison. Semantic analysis, powered by models like BERT or sentence transformers, benchmarks organizational electronic documents against industry standards and regulatory requirements. This allows the system to compute similarity scores between electronic documents and compliance mandates, identifying alignment or deviations.

By consolidating and processing this extensive range of data, the platform enables the A l-powered electronic document nexus to deliver actionable insights, including benchmarking scores, risk assessments, and compliance gap analyses. This integration not only helps organizations maintain regulatory alignment but also drives strategic improvements to their electronic documents, ensuring they stay ahead in an ever-evolving compliance landscape.

Method 800 then proceeds to step 804 with electronic document generation and evaluation. Briefly, the AI-powered electronic document nexus generates new electronic documents and evaluates existing ones using its proprietary algorithm. This process includes aligning electronic documents with regulatory standards and organizational goals and providing recommendations for improvements.

Specifically, the AI-powered electronic document nexus leverages its proprietary algorithm to both generate new electronic documents and evaluate existing ones with precision and efficiency. By integrating advanced NLP and machine learning techniques, the system ensures that electronic documents are not only aligned with regulatory standards but also tailored to meet the specific goals and operational needs of the organization.

For electronic document generation, the system draws from a comprehensive database of regulatory requirements, industry benchmarks, and internal organizational guidelines. It synthesizes this information to produce electronic document drafts that incorporate best practices, comply with relevant laws, and address organizational objectives. These drafts are structured using predefined templates that ensure clarity, consistency, and completeness, while still allowing for customization to suit specific business contexts.

When evaluating existing electronic documents, the AI-powered electronic document nexus analyzes their content against regulatory standards and benchmarks using its algorithmic framework. The process involves identifying gaps, ambiguities, or redundancies in electronic document language and assessing their alignment with both legal requirements and organizational strategies. Advanced risk assessment models are employed to flag areas of potential non-compliance or operational inefficiency, while comparative analysis benchmarks electronic documents against industry leaders to measure maturity and effectiveness.

The system generates detailed recommendations for electronic document improvement, which can range from incorporating missing clauses to refining language for clarity and enforceability. These recommendations are prioritized based on factors such as risk severity, regulatory deadlines, and alignment with organizational goals. By continuously learning from new data and feedback, the AI-powered electronic document nexus ensures that its outputs remain dynamic, relevant, and aligned with the evolving regulatory landscape, enabling organizations to maintain robust, forward-looking electronic documents. In some embodiments, the query engine 630 may leverage machine learning-based relevance tuning, and dynamically refine search results based on historical queries, compliance trends, and user interaction patterns. This ensures that frequently accessed or high-risk electronic documents are prioritized in search results, improving efficiency in document retrieval and adherence monitoring.

In some embodiments, the query engine 630 may integrate with compliance reporting systems to automatically flag recurring adherence gaps and recommend corrective actions. By analyzing patterns in content acknowledgments and compliance responses, the system may proactively suggest document refinements, targeted training initiatives, or stricter enforcement measures, ensuring continuous document-guided enforcement and regulatory alignment.

Method 800 then proceeds to step 806 for risk categorization and content analysis. Briefly, the content intelligence hub categorizes risks associated with existing electronic documents and performs content analysis to eliminate biases. It generates action plans and adjustments based on the identified risks and continuous learning from new data inputs.

Specifically, the content intelligence hub plays an essential role in strengthening electronic document frameworks by categorizing risks, performing in-depth content analysis, and providing actionable solutions. Utilizing advanced NLP and machine learning techniques, the hub evaluates existing electronic documents to identify risks associated with non-compliance, operational inefficiencies, and potential gaps. It classifies these risks into categories such as regulatory non-conformance, ambiguous language, or inadequate coverage of essential areas, enabling organizations to prioritize their remediation efforts effectively.

A key feature of the hub is its ability to perform content analysis to detect and eliminate biases in electronic document language. This includes identifying language that may inadvertently exclude certain demographics, violate fairness principles, or create inequities. Through semantic analysis and sentiment detection, the system flags problematic language and provides alternative wording to promote inclusivity, clarity, and alignment with ethical standards.

The content intelligence hub also generates targeted action plans and electronic document adjustments based on the risks it identifies. These action plans are tailored to address specific issues, such as updating clauses to meet regulatory requirements, restructuring electronic documents for better enforceability, or adding provisions to cover previously overlooked areas. Leveraging its continuous learning capabilities, the hub refines its risk categorization and recommendations by analyzing new data inputs, such as regulatory updates, organizational feedback, or changes in industry standards. In some embodiments, the content intelligence hub may implement transformer-based contextual embeddings and graph-based semantic similarity analysis to detect discrepancies, redundancies, or conflicts across related electronic documents. By constructing multi-layer vector representations of content text, the system may assess inter-document dependencies, ensuring regulatory coherence and minimizing document fragmentation recalibration.

In some embodiments, the content intelligence hub may integrate an adaptive reinforcement learning framework that continuously refines its risk classification models based on real-time regulatory updates, historical compliance deviations, and feedback from respective entities. The system applies Bayesian optimization techniques to iteratively adjust classification thresholds, improving predictive accuracy in identifying high-risk content gaps and enabling proactive content.

By delivering precise insights and practical solutions, the content intelligence hub empowers organizations to mitigate risks, enhance the quality of their electronic documents, and ensure alignment with both regulatory requirements and organizational values. This dynamic approach fosters resilience and adaptability in the face of an ever-evolving compliance landscape.

Method 800 then proceeds to step 808 with dynamic electronic document updates. Briefly, the autonomous electronic document renewer continuously monitors regulatory changes and organizational shifts, dynamically updating electronic documents to ensure compliance. This process includes real-time adaptation to new regulations and organizational needs.

Specifically, the autonomous electronic document renewer is a dynamic system designed to ensure that organizational electronic documents remain compliant and up to date in the face of evolving regulatory requirements and organizational changes. Using real-time monitoring tools and advanced algorithms, the system continuously tracks updates from regulatory bodies, industry standards, and internal operational shifts. By integrating these changes promptly, it enables organizations to maintain compliance without requiring manual intervention.

The Electronic document Renewer employs automated processes to identify and analyze relevant regulatory updates. Through APIs, web scraping, and subscription feeds from regulatory bodies, it gathers information on new or modified rules. Internally, the system monitors organizational changes, such as structural realignments, strategic shifts, or operational updates, by interfacing with enterprise systems like human resources (HR) databases, project management tools, and compliance platforms.

Once changes are detected, the system evaluates their impact on existing electronic documents. Leveraging NLP and machine learning models, it identifies specific electronic document clauses that require updates or additions. It then dynamically updates these electronic documents using predefined templates and context-aware algorithms to ensure that all modifications are both compliant and aligned with organizational goals.

For significant changes, the system generates draft updates for review, accompanied by detailed impact reports outlining the rationale and compliance implications. For minor adjustments, such as date changes or minor rewording, the updates are implemented directly with an audit trail for tracking. By maintaining real-time synchronization with regulatory environments and organizational needs, the autonomous electronic document renewer minimizes compliance risks, reduces the administrative burden, and ensures that electronic documents remain current and effective.

The method 800 then proceeds to step 810 with relevant entity engagement and education. Briefly, the system conducts autonomous adoption campaigns, educating relevant entities about electronic document changes and ensuring their engagement. Feedback from these campaigns is used to further refine and improve electronic document implementation.

Specifically, the system conducts autonomous adoption campaigns to ensure relevant entities are well-informed about electronic document changes and actively engaged in their implementation. These campaigns are designed to streamline communication, enhance understanding, and drive adoption by leveraging advanced automation and personalization techniques.

When an electronic document is updated or newly introduced, the system automatically identifies relevant entities based on their roles, responsibilities, and departmental affiliations. Tailored communication plans are generated for each entity group, using channels such as email, Slack®, Microsoft® Teams, or a centralized electronic document portal. These communications include key details about the electronic document changes, such as their purpose, scope, and implementation timelines, presented in a clear and concise format.

The system employs interactive educational tools, such as webinars, e-learning modules, and electronic document walkthroughs, to ensure relevant entities fully understand the changes. Quizzes, surveys, and acknowledgment requests are incorporated to measure engagement levels and confirm comprehension. For high-priority electronic documents, the system uses behavioral insights to send reminders or follow-ups to relevant entities who have yet to review or acknowledge the changes.

Feedback collected during these campaigns, whether through direct surveys or usage analytics, is analyzed to identify areas where the electronic document content or communication strategy may need improvement. This feedback loop ensures that future electronic documents are not only more aligned with organizational needs but are also more effectively communicated to relevant entities. By automating the process, the system fosters a culture of compliance and collaboration while continuously refining its approach to electronic document education and engagement.

The method 800 then proceeds to step 812 with real-time monitoring and adjustments. Briefly, the system employs real-time monitoring tools to track electronic document adherence. It detects deviations and implements corrective actions automatically, maintaining continuous compliance and electronic document processing efficiency.

Specifically, the system leverages real-time monitoring tools to ensure continuous electronic document adherence and efficient management. These tools are integrated with organizational processes and systems, enabling the platform to track compliance metrics, user actions, and adherence to electronic document requirements in real time. By continuously analyzing data from internal systems such as HR platforms, operational logs, and adherence tracking modules, the system provides a clear, up-to-date picture of electronic document implementation across the organization.

When deviations from electronic documents are detected, such as failure to follow compliance procedures, missed acknowledgment deadlines, or operational inconsistencies, the system immediately flags these issues. It categorizes deviations by severity, urgency, and potential impact, triggering automated corrective actions based on predefined workflows. For example, in the case of non-compliance with a cybersecurity electronic document, the system might automatically restrict access to sensitive systems until the necessary steps are taken.

Corrective actions may include automated reminders, additional training assignments, escalation to supervisors, or direct system interventions to mitigate risks. Each action is logged and tracked to ensure accountability and transparency, with progress reports made available to relevant entities. Furthermore, the system learns from historical deviations and their resolutions, using this data to improve its predictive and corrective capabilities over time.

By combining real-time monitoring, automated responses, and intelligent learning, the system ensures continuous compliance and minimizes the administrative burden of manual oversight. This proactive approach significantly enhances electronic document adherence, reduces compliance risks, and ensures that electronic document processing remains efficient and adaptive to dynamic organizational needs.

The system and framework for electronic document benchmarking is a tightly interconnected ecosystem, built on a central AI-driven platform that ensures seamless data flow and integration across its various components. At its core is the AI-powered electronic document nexus, which acts as the foundation for the entire framework. This central hub aggregates, processes, and analyzes data from internal and external sources, serving as the backbone for electronic document evaluation, benchmarking, and generation.

The content intelligence hub and the autonomous electronic document renewer are directly linked to the AI-powered electronic document nexus, creating a symbiotic relationship to ensure electronic documents remain relevant, compliant, and effective. The content intelligence hub specializes in analyzing electronic document content, categorizing risks, eliminating biases, and generating actionable improvement plans. The autonomous electronic document renewer complements this by continuously monitoring regulatory changes and organizational shifts, and dynamically updating electronic documents to reflect evolving requirements and operational needs. Together, these modules maintain the integrity, accuracy, and applicability of electronic documents in real time.

To ensure successful implementation and adherence, the framework includes autonomous adoption campaigns and real-time monitoring tools. These components drive engagement of relevant entities by educating them on electronic document updates through personalized campaigns, interactive tools, and feedback mechanisms. The feedback is analyzed and routed back into the system to refine both the electronic documents and their dissemination strategies. Real-time monitoring tools track electronic document adherence across the organization, detecting deviations and triggering corrective actions to maintain compliance efficiently.

This integrated approach enables the system to function as a cohesive and adaptive electronic document processing framework. By ensuring data flows seamlessly between modules and creating feedback loops that drive continuous improvement, the platform empowers organizations to maintain regulatory alignment, mitigate risks, and optimize electronic document governance across their lifecycles.

The system and framework for electronic document benchmarking represent a significant advancement over traditional solutions by leveraging advanced technologies to deliver a comprehensive, adaptive, and efficient electronic document processing system. Its real-time capabilities enable the system to dynamically respond to regulatory updates and organizational shifts, eliminating the reliance on manual processes and reducing the risk of outdated or non-compliant electronic documents. By incorporating machine learning and natural language processing, it identifies and mitigates biases, ensuring that electronic documents are inclusive, equitable, and aligned with ethical standards.

This framework enforces strict adherence to regulatory requirements, providing relevant entities with electronic documents that are consistently clear, concise, and actionable. Its ability to evaluate and refine electronic documents in real time strengthens governance processes, enhances risk management, and ensures compliance at every organizational level. The system's centralized AI-driven architecture integrates data across modules, offering a holistic view of electronic documents and enabling better control over electronic document implementation and monitoring.

### Implementing Device

In some embodiments, the various intelligent spreadsheet analyzing application systems disclosed herein may be implemented on a computing system with access to a hard disc or remote storage, as further described in detail below.

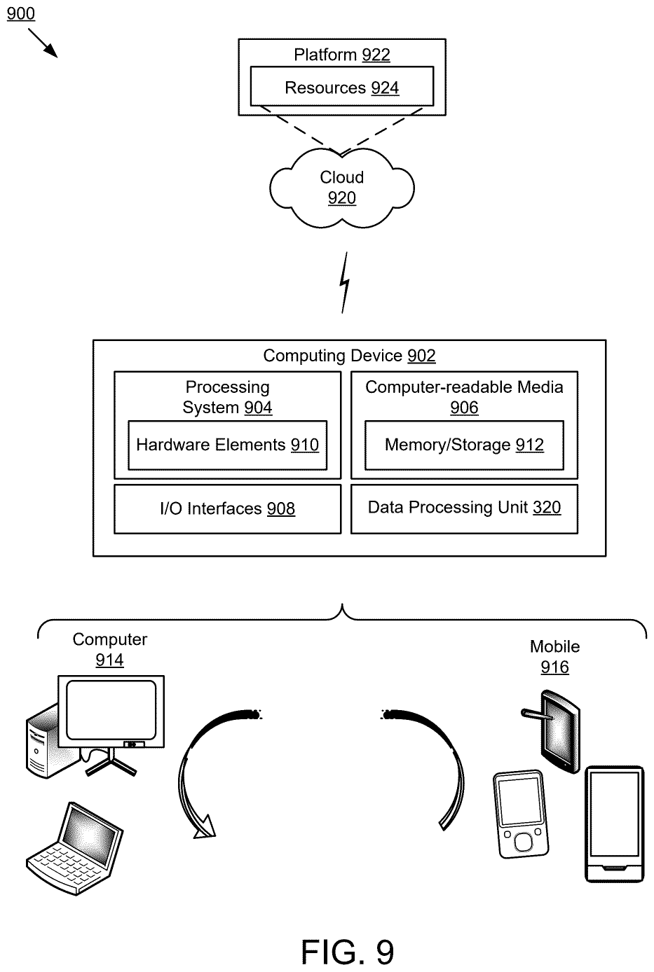

FIG. 9 illustrates an example system 900 that, generally, includes an example computing device 902 that is representative of one or more computing systems and/or devices that may implement the various techniques described herein.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of the functionality to perform one or more operations using hardware. Accordingly, the processing system 904 is illustrated as including hardware element 910 that may be configured as processors, functional blocks, and so forth. This may include implementation in hardware as an application-specific integrated circuit (A SIC) or other logic devices formed using one or more semiconductors. The hardware elements 910 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable media 906 is illustrated as including memory/storage 912. The memory/storage 912 represents memory/storage capacity associated with one or more computer-readable media. The memory/storage 912 may include volatile media (such as random-access memory (RAM)) and/or nonvolatile media (such as read-only memory (ROM), Flash memory, optical disks, magnetic disks, and so forth). The memory/storage 912 may include fixed media (e.g., RAM, ROM, a fixed hard drive, and so on) as well as removable media, e.g., Flash memory, a removable hard drive, an optical disc, and so forth. The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 910 and computer-readable media 906 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an A SIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of an engine that is executable by the computing device 902 as software may be achieved at least partially in hardware, e.g., through the use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for providing one or more device-specific AI engines, which can be further personalized. This improves the performance of an AI engine not only due to its compatibility with specific device constraints but also due to its personalized output.

In the example system 900, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 902 may assume a variety of different configurations, such as for computer 914 and mobile 916 uses, and for many enterprise use, IoT use, and many other uses not illustrated in FIG. 9. Each of these configurations includes devices that may have generally different constructs and capabilities, and thus the computing device 902 may be configured according to one or more of the different device classes. For instance, the computing device 902 may be implemented as the computer 914 family of a device that includes a personal computer, desktop computer, multi-screen computer, laptop computer, netbook, and so on. The computing device 902 may also be implemented as the mobile 916 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 902 and are not limited to the specific examples of the techniques described herein. This is illustrated through the inclusion of a data processing unit 320 on the computing device 902, where the data processing unit 320 may include different units or modules as illustrated in FIGS. 1-7. The functionality represented by data processing unit 320 and other modules/applications may also be implemented all or in part through the use of a distributed system, such as over a “cloud” 920 via a platform 922 as described below.

The cloud 920 includes and/or is representative of platform 922 for resources 924. The platform 922 abstracts the underlying functionality of hardware (e.g., servers) and software resources of the cloud 920. Resources 924 may include applications and/or data that can be utilized while computer processing is executed on servers that are remote from the computing device 902. Resources 924 can also include services provided over the internet and/or through a subscriber network, such as a cellular or Wi-Fi network.

The platform 922 may abstract resources and functions to connect the computing device 902 with other computing devices 914 or 916. The platform 922 may also serve to abstract the scaling of resources to provide a corresponding level of scale to encountered demand for the resources 924 that are implemented via platform 922. Accordingly, in an interconnected device implementation, the implementation functionality described herein may be distributed throughout system 900. For example, the functionality may be implemented in part on the computing device 902 as well as via the platform 922 which abstracts the functionality of the cloud 920.

### ADDITIONAL CONSIDERATIONS

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. An electronic document processing platform, comprising:
a multi-layer control graph, wherein interconnected nodes within a multi-layered structure of the control graph comprise electronic documents stored at one or more locations in a computing network, and wherein edges of the control graph comprise relationships among the electronic documents including shared risks, cascading impacts, and operational dependencies;
an adaptive dimension algorithm module configured to dynamically scan contents associated with the electronic documents; and
a generative compliance engine configured to synthesize the contents associated with the electronic documents based on the relationships in the control graph.

2. The electronic document processing platform of claim 1, wherein the adaptive dimension algorithm module includes a graph diffusion algorithm configured to propagate changes across the graph when an electronic document associated with a node is updated.

3. The electronic document processing platform of claim 1, wherein the multi-layer control graph includes a control layer including a set of nodes representing control elements for the multi-layer control graph, a risk layer including a set of nodes representing risk dimensions mapped to one or more electronic documents, and a benefits layer including a set of nodes representing measurable outcomes from implementations associated with one or more electronic documents.

4. The electronic document processing platform of claim 1, wherein the adaptive dimension algorithm module is configured to combine tensor decomposition with a multi-agent reinforcement learning (RL) framework to implement real-time, multi-dimensional electronic document evaluation.

5. The electronic document processing platform of claim 1, further comprising:
a data storage and management unit configured for centralizing and managing data for electronic document analysis;
an AI ingestion layer configured for analyzing, generating, and evaluating one or more electronic documents;
a real-time monitoring layer configured for tracking electronic document adherence and regulatory changes;
an automation and workflow engine configured for automating updates and corrective actions; and
one or more user interfaces configured for interaction and visualization.

6. The electronic document processing platform of claim 5, wherein the AI ingestion layer includes a data integration pipeline to aggregate information out of data from one or more internal and external sources.

7. The electronic document processing platform of claim 6, wherein the data from the internal and external sources include data from one or more of an industry-specific database, regulatory body, or organizational repository.

8. The electronic document processing platform of claim 5, wherein the AI ingestion layer includes an adoption assessment engine configured to analyze electronic document adoption metrics including acknowledgment rates and adherence percentages.

9. The electronic document processing platform of claim 8, wherein the adoption assessment engine is configured to use one or more natural language processing (NLP) models to analyze language and structure of the electronic documents and use one or more rule-based engines to evaluate compliance and effectiveness.

10. The electronic document processing platform of claim 9, wherein the one or more NLP models are further configured to evaluate existing electronic documents to identify risks associated with non-compliance, operational inefficiencies, and potential gaps.

11. The electronic document processing platform of claim 9, wherein the one or more NLP models are further configured to implement a dimension algorithm to classify the risks into categories including regulatory non-conformance, ambiguous language, or inadequate coverage of essential areas.

12. The electronic document processing platform of claim 5, wherein the AI ingestion layer includes an audit observation engine configured to track audit findings, map the audit findings to one or more electronic documents, and generate compliance recommendations.

13. The electronic document processing platform of claim 5, wherein the AI ingestion layer includes an electronic document generation engine configured to automatically create new electronic documents tailored to specific requirements.

14. The electronic document processing platform of claim 13, wherein the electronic document generation engine includes one or more NLP models to drive text generation of electronic documents that align with predefined templates and regulations.

15. The electronic document processing platform of claim 14, wherein the one or more NLP models are configured to customize electronic document generation based on industry and organizational context.

16. The electronic document processing platform of claim 5, wherein the real-time monitoring layer is configured to track updates from regulatory bodies and changes in organizational structures.

17. The electronic document processing platform of claim 5, wherein the automation and workflow engine is configured to automatically modify one or more electronic documents to align with new standards or internal requirements.

18. The electronic document processing platform of claim 5, wherein the automation and workflow engine is configured to assess effects of changes on existing electronic documents and generate detailed update reports.

19. The electronic document processing platform of claim 5, wherein the automation and workflow engine includes an autonomous electronic document renewer configured to dynamically update one or more electronic documents by employing a dimension algorithm that incorporates changes in organizational structures, strategic risk profiles, and regulatory requirements.

20. The electronic document processing platform of claim 5, wherein the real-time monitoring layer includes one or more feedback collection tools integrated with APIs for feedback collection.

21. The electronic document processing platform of claim 5, wherein the real-time monitoring layer includes a sentiment analysis module configured to process feedback from respective entities, assess adoption levels, and dynamically adjust compliance recommendations based on sentiment trends and acknowledgment patterns.

22. The electronic document processing platform of claim 3, wherein the multi-layer control graph includes a risk diffusion model configured to propagate risk scores across interconnected electronic documents, and adjust compliance priorities dynamically in response to regulatory updates, operational changes, and cross-document dependencies.

23. The electronic document processing platform of claim 1, wherein the adaptive dimension algorithm module includes an optimization engine configured to minimize computational overhead by selectively scanning high-impact electronic documents, prioritizing processing based on risk assessment, document significance, and real-time compliance changes.

24. The electronic document processing platform of claim 1, wherein the adaptive dimension algorithm module includes an anomaly detection module configured to apply spectral clustering and graph-based analysis to identify redundant controls, conflicting content, or overlooked risks within an electronic document framework.

25. The electronic document processing platform of claim 6, wherein the AI ingestion layer includes an external compliance data integration module configured to ingest regulatory updates from external APIs, dynamically update risk classification models, and modify electronic document structures to maintain regulatory alignment in real time.

26. A system for electronic document processing, comprising:
a processor; and
a memory, coupled to the processor, configured to store executable instructions that, when executed by the processor, cause the processor to perform operations including:
generating a multi-layer control graph, wherein interconnected nodes within a multi-layered structure of the control graph comprise electronic documents stored at one or more locations in a computing network, and wherein edges of the control graph comprise relationships among the electronic documents including shared risks, cascading impacts, and operational dependencies;
dynamically scanning contents associated with the electronic documents; and
synthesizing the contents associated with the electronic documents based on the relationships in the control graph.

27. The system of claim 26, wherein dynamically scanning contents associated with the electronic documents comprises:
tracking updates from regulatory bodies and changes in organizational structures.

28. The system of claim 26, wherein dynamically scanning contents of the electronic document comprises:
combining tensor decomposition with a multi-agent RL framework to implement real-time, multi-dimensional electronic document evaluation.

29. The system of claim 26, wherein synthesizing the contents associated with the electronic documents based on the relationships in the control graph comprises:
dynamically updating one or more electronic documents by employing a dimension algorithm that incorporates changes in organizational structures, strategic risk profiles, and regulatory requirements.

30. The system of claim 26, wherein synthesizing the contents associated with the electronic documents based on the relationships in the control graph comprises:
propagating changes across the graph when an electronic document associated with a node is updated.
